(19) United States
(12) Patent Application Publication
(10) Pub. No.: US 2025/0252413 A1
(43) Pub. Date: Aug. 7, 2025

(54) SYSTEM AND METHOD FOR PROVIDING SINGLE DIGITAL PRODUCT ACQUISITION FROM A DIGITAL SUBSCRIPTION SERVICE

(71) Applicant: Subly Media Inc., Redmond, WA (US)

(72) Inventors: Jason Upton, Redmond, WA (US); Jim Moore, Redmond, WA (US)

(21) Appl. No.: 19/047,452

(22) Filed: Feb. 6, 2025

Related U.S. Application Data
(60) Provisional application No. 63/550,984, filed on Feb. 7, 2024.

(51) Int. Cl. G06Q 20/12; G06Q 20/06; G06Q 30/0601

(52) U.S. Cl. CPC G06Q 20/123; G06Q 20/06; G06Q 30/0641

(57) ABSTRACT

A method for enabling a single digital product acquisition from an on-line media partner. The method includes: providing an interface system that is managing access to digital content of the on-line media partner through a paywall system; receiving, at the interface system, a request to access a portion of digital content from the on-line media partner from a user that is a non-subscriber of the on-line media partner; determining, by the interface system, if the user that is requesting access to the portion of digital content from the on-line media partner is a customer of the interface system; and in response to receiving sufficient tokens from the customer of the interface system to access the portion of digital content from the on-line media partner, enabling display of the portion of digital content from the on-line media partner to the customer of the interface system.

### BACKGROUND

### Technical Field

The present application pertains to on-line digital subscription services, and more particularly, to a system and method for obtaining on-line single digital product acquisition from on-line digital subscription services.

### Description of the Related Art

Before the wide adoption of the Internet, most information (e.g., news, entertainment, weather, research, science, etc.) was provided on a daily, weekly, or other cycle by printed media, such as newspapers, magazines, periodicals, books, and the like. When the Internet became more widely accepted, many media companies, both large and small, started to release some if not all of this information over the Internet. Typically, this was a hybrid model where the newspaper or magazine was available both in print and digitally. There were many benefits to this new digital distribution means. For example, there were no costs for consumable printing components such as paper and ink. Additionally, many of the previous geographical restrictions either no longer existed or when dramatically reduced.

However, there were new shortcomings that arose as well. For example, so many people now had access to information for free that they previously paid for in newspaper or magazine subscriptions that these people started to cancel their subscriptions to the printed media. In response, many printed media companies that had been offering free digital media started to place their digital media offerings behind paywalls so that only paying subscribers could view their content.

This paywalls trend in the media has led to still further problems though. More and more, consumers of on-line media content come to digital media articles and other content through search engines and other similar means. This results in consumers being led to content by digital media companies that they may only visit sporadically, and thus, these consumers are unwilling to become long term subscribers to these digital media companies. As a result, these digital media companies are losing the opportunity for new customers, and the consumers are missing the opportunity to be exposed to new digital media companies that they might grow to love. Currently, there is no technological solution for such consumers to sample digital media without the full subscription commitment that is typically being offered.

Furthermore, there is a continuing desire to provide digital media consumers with a technological methodology to sample digital media behind a digital paywall without the full subscription commitment. The present disclosure addresses this and other needs.

### BRIEF SUMMARY

Briefly stated, embodiments of the present disclosure are directed towards a system and method for enabling a single digital product acquisition from an on-line media partner. In one or more embodiments, a system for enabling a single digital product acquisition from an on-line media partner is disclosed. In such embodiments, a paywall system manages digital content of the on-line media partner to block non-subscribers of the on-line media partner from accessing the digital content of the on-line media partner. In one or more embodiments, the digital content includes a plurality of portions of digital content. The system includes a memory that stores computer instructions and a processor that when executing the computer instructions causes the system to: enable an interface system to allow access to the digital content of the on-line media partner through the paywall system by a non-subscriber of the on-line media partner that is a customer of the interface system; receive, at the interface system, a request to access a portion of digital content controlled by the on-line media partner from a user that is a non-subscriber of the on-line media partner; determine, by the interface system, if the user that is requesting access to the portion of digital content controlled by the on-line media partner is a customer of the interface system; when the user that is requesting access to the portion of digital content controlled by the on-line media partner is a customer of the interface system, determine that the user that is requesting access has sufficient tokens to access the portion of digital content controlled by the on-line media partner; and in response to receiving the sufficient tokens to access the portion of digital content controlled by the on-line media partner, enable display of the portion of digital content controlled by the on-line media partner.

In other embodiments, the interface system is referred to as the single digital product acquisition system (SDPAS) or simply “Subly”. In still other embodiments, the interface system may be used by customers of the interface system to interact with entities other than on-line media partners such as professional journals, academic journals, periodicals, and the like. In still other embodiments, the interface system may be used by customers of the interface system to interact with entities other than digital content suppliers (where customers do not want hassle of creating another account, password, personal information, etc.), such as parking lots, paid street parking, or other membership services.

In some embodiments of a system for enabling a single digital product acquisition, the memory includes further computer instructions that when executing the computer instructions further cause the system to: if the user that is requesting access to a portion of digital content controlled by the on-line media partner is not a customer of the interface system, prompt the user that is requesting access to join the interface system. In another aspect of some embodiments, the memory includes further computer instructions that when executing the computer instructions further cause the system to: if the interface system determines that the user requesting access is a customer of the interface system but does not have sufficient tokens to access to the digital content of the on-line media partner, enable the requesting user to acquire more tokens; and initiate communication with a payment operator to enable the requesting user to acquire more tokens. In still another aspect of some embodiments, the paywall system manages digital content of an on-line media partner using Content Management System (CMS). In yet another aspect of some embodiments, the interface system is operatively connected with a payment operator to enable a customer of the interface system to transfer funds for one time use digital tokens.

In one or more embodiments of a system for enabling a single digital product acquisition, the memory includes further computer instructions that when executing the computer instructions further cause the system to: enable the paywall system to check if a user requesting access to a portion of digital content controlled by the on-line media partner is a customer of the interface system; and if the paywall system determines that the user requesting access to a portion of digital content controlled by the on-line media partner is a customer of the interface system, provide access to the portion of digital content controlled by the on-line media partner once the portion of digital content has been brokered by the customer of the interface system. In another aspect of some embodiments, the interface system is integrated into a website of the on-line media partner as a plug-in to enable presentation of the interface system in an iFrame. In still another aspect of some embodiments, the digital content includes a plurality of portions of digital content, and wherein the interface system coordinates with the on-line media partner to include an interface system link to each of the plurality of portions of digital content. In yet another aspect of some embodiments, the digital content controlled by the on-line media partner that are requested by users are downloaded to the user's browser, and the interface system manages whether the digital content controlled by the on-line media partner are viewable based on the user's status as a customer of the interface system.

In another embodiment, an additional system for enabling a single digital product acquisition from an on-line media partner is disclosed. In such embodiments, a paywall system manages digital content of the on-line media partner to block non-subscribers of the on-line media partner from accessing the digital content of the on-line media partner using a server-side paywall. In some embodiments of a system for enabling a single digital product acquisition, the memory includes further computer instructions that when executing the computer instructions further cause the system to: receive, at the interface system, a request to access the digital content controlled by the on-line media partner from a user that is a non-subscriber of the on-line media partner, wherein the request is forwarded from the paywall system that received the request to access the digital content controlled by the on-line media partner from the user; determine, by the interface system, if the user that is requesting access to the digital content controlled by the on-line media partner is a customer of the interface system; when the user that is requesting access to the digital content controlled by the on-line media partner is a customer of the interface system, determine that the user requesting access has sufficient tokens to access the digital content controlled by the on-line media partner; in response to determining that sufficient tokens have been received to enable access the digital content controlled by the on-line media partner from the user, enable download of the digital content controlled by the on-line media partner to a computer at which the user is requesting access; and enable display of the downloaded digital content controlled by the on-line media partner on the computer at which the user is requesting access.

In some embodiments of a system for enabling a single digital product acquisition, the memory includes further computer instructions that when executing the computer instructions further cause the system to: if the user that is requesting access to the digital content controlled by the on-line media partner is not a customer of the interface system, prompt the user that is requesting access to join the interface system. In another aspect of some embodiments, the memory includes further computer instructions that when executing the computer instructions further cause the system to: if the interface system determines that the user requesting access is a customer of the interface system but does not have sufficient tokens to access to the digital content of the on-line media partner, enable the requesting user to acquire more tokens; and initiate communication with a payment operator to enable the requesting user to acquire more tokens. In still another aspect of some embodiments, the memory includes further computer instructions that when executing the computer instructions further cause the system to: in response to determining that sufficient tokens have been received to enable access the digital content controlled by the on-line media partner from the user, download an interface system platform to the computer at which the user is requesting access. In yet another aspect of some embodiments, the memory includes further computer instructions that when executing the computer instructions further cause the system to: in response to determining that sufficient tokens have been received to enable access the digital content controlled by the on-line media partner from the user, instantiate an interface system platform to the computer at which the user is requesting access.

In other embodiments of a system for enabling a single digital product acquisition, the memory includes further computer instructions that when executing the computer instructions further cause the system to: after instantiating an interface system platform to the computer at which the user is requesting access, adding user interface elements to the server-side paywall of the paywall system that manages digital content of the on-line media partner to block non-subscribers of the on-line media partner from accessing the digital content of the on-line media partner. In another aspect of some embodiments, the digital content of the on-line media partner that is accessible by the user via the interface system is a single digital product. In still another aspect of some embodiments, the digital content of the on-line media partner that is accessible by the user via the interface system is multiple digital products. In yet another aspect of some embodiments, the digital content of the on-line media partner that is accessible by the user via the interface system is either (1) all the on-line media partner's digital content for a set period of time, or (2) a subset of the on-line media partner's digital content for a set period of time.

In another embodiment, an additional system for enabling a single digital product acquisition from an on-line media partner is disclosed. In such embodiments, a paywall system manages digital content of the on-line media partner to block non-subscribers of the on-line media partner from accessing the digital content of the on-line media partner using a server-side paywall. In some embodiments of a system for enabling a single digital product acquisition, the memory includes further computer instructions that when executing the computer instructions further cause the system to: receive, at the interface system, a request to access the digital content controlled by the on-line media partner from a user that is a non-subscriber of the on-line media partner, wherein the request is forwarded from the paywall system that received the request to access the digital content controlled by the on-line media partner from the user; determine, by the interface system, that the user requesting access to the digital content controlled by the on-line media partner is not a customer of the interface system; enable, by the interface system, the user requesting access to the digital content controlled by the on-line media partner an opportunity to become a customer of the interface system; in response to new user sign up actions by the user, establishing the user requesting access to the digital content controlled by the on-line media partner as a customer of the interface system; determine if the user requesting access has sufficient tokens to access the digital content controlled by the on-line media partner; in response to determining that sufficient tokens have been received to enable access the digital content controlled by the on-line media partner from the user, enable download of the digital content controlled by the on-line media partner to a computer at which the user is requesting access; and enable display of the downloaded digital content controlled by the on-line media partner on the computer at which the user is requesting access.

In some embodiments of a system for enabling a single digital product acquisition, the memory includes further computer instructions that when executing the computer instructions further cause the system to: if the user that is requesting access to the digital content controlled by the on-line media partner is not a customer of the interface system, prompt the user that is requesting access to join the interface system. In another aspect of some embodiments, the memory includes further computer instructions that when executing the computer instructions further cause the system to: if the interface system determines that the user requesting access is a customer of the interface system but does not have sufficient tokens to access to the digital content of the on-line media partner, enable the requesting user to acquire more tokens; and initiate communication with a payment operator to enable the requesting user to acquire more tokens. In still another aspect of some embodiments, the memory includes further computer instructions that when executing the computer instructions further cause the system to: in response to determining that sufficient tokens have been received to enable access the digital content controlled by the on-line media partner from the user, download an interface system platform to the computer at which the user is requesting access. In yet another aspect of some embodiments, the memory includes further computer instructions that when executing the computer instructions further cause the system to: in response to determining that sufficient tokens have been received to enable access the digital content controlled by the on-line media partner from the user, instantiate an interface system platform to the computer at which the user is requesting access.

In other embodiments of a system for enabling a single digital product acquisition, the memory includes further computer instructions that when executing the computer instructions further cause the system to: after instantiating an interface system platform to the computer at which the user is requesting access, adding user interface elements to the server-side paywall of the paywall system that manages digital content of the on-line media partner to block non-subscribers of the on-line media partner from accessing the digital content of the on-line media partner. In another aspect of some embodiments, the digital content of the on-line media partner that is accessible by the user via the interface system is a single digital product. In still another aspect of some embodiments, the digital content of the on-line media partner that is accessible by the user via the interface system is multiple digital products. In yet another aspect of some embodiments, the digital content of the on-line media partner that is accessible by the user via the interface system is either (1) all the on-line media partner's digital content for a set period of time, or (2) a subset of the on-line media partner's digital content for a set period of time.

The embodiments described in the present disclosure improve upon known data storage architectures, structures, processes, and techniques in a variety of different computerized technologies, such as operating systems, user interfaces, and social networks.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings:

FIG. 1 illustrates a context diagram of a legacy system used to purchase a subscription for all content from an on-line media partner;

FIG. 2 illustrates a graphical representation of a plurality of on-line media partners that are being managed by a plurality of paywall systems and a single digital product acquisition system (SDPAS) that assists a customer with making an acquisition of a single digital product, rather than a full subscription, in accordance with embodiments described herein;

FIG. 3 illustrates a logical flow diagram for a single digital product acquisition method that uses a script link, in accordance with embodiments described herein;

FIG. 4 illustrates a functional flow diagram of the script for the SDPAS, in accordance with embodiments described herein;

FIG. 5A illustrates an on-line media partner's website showing several selectable article headings;

FIG. 5B illustrates an on-line media partner's website after a selectable article has attempted to be viewed and a subscription requirement banner has been launched;

FIG. 5C illustrates an on-line media partner's website having a subscription requirement banner and two virtual buttons for the SDPAS;

FIG. 5D illustrates an on-line media partner's website having a subscription requirement banner after a virtual button for the SDPAS has been pressed by a customer and confirmation is provided;

FIG. 5E illustrates an on-line media partner's website with the selected article being viewed after the customer of the SDPAS confirmed acquisition of the selected article;

FIG. 6 illustrates a logic diagram showing a method for enabling a SDPAS from an on-line media partner;

FIG. 7 illustrates a logical flow diagram for an embodiment in which a SDPAS or non-SDPAS customer visits a media partner website with server side paywall technology and no SDPAS customer token in the URL;

FIG. 8 illustrates a logical flow diagram for an embodiment in which a SDPAS customer visits a media partner website with server side paywall technology, a SDPAS customer token in the URL, and no customer purchase recognized;

FIG. 9 illustrates a logical flow diagram for an embodiment in which a SDPAS customer visits a media partner website with server side paywall technology, a SDPAS customer token in the URL, and a customer prior purchase is recognized;

FIGS. 10A and 10B illustrate a logical flow diagram for another embodiment in which a SDPAS customer visits a media partner website with server side paywall technology, and there is no SDPAS customer token in the URL;

FIGS. 11A-11F illustrate a logical flow diagram for another embodiment in which a SDPAS customer visits a media partner website with server side paywall technology, and there is a SDPAS customer token in the URL; and

FIG. 12 illustrates a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, and the like. In other instances, well-known structures or components that are associated with the environment of the present disclosure, including but not limited to the communication systems and networks and the automobile environment, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

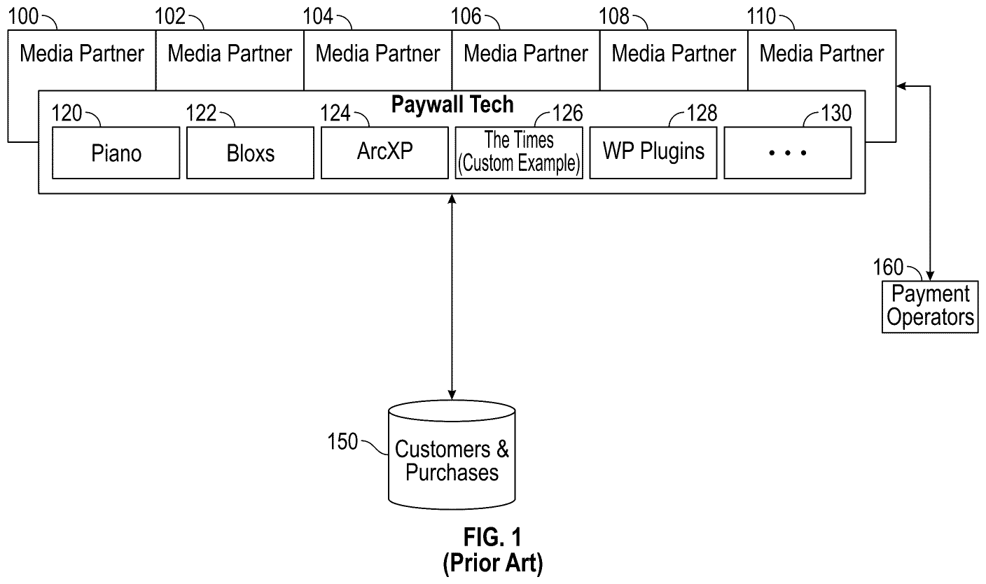

FIG. 1 illustrates a context diagram of a legacy system that includes a plurality of on-line media partners 100, 102, 104, 106, 108, 110; a corresponding number of paywall systems 120, 122, 124, 126, 128, 130; one or more customers 150; and payment operators 160. In this system, the plurality of on-line media partners 100, 102, 104, 106, 108, 110 are managed by the corresponding number of paywall systems 120, 122, 124, 126, 128, 130. In such prior systems, the paywall systems 120, 122, 124, 126, 128, 130 interact with the customer 150 on behalf of the plurality of on-line media partners 100, 102, 104, 106, 108, 110. Typically, the paywall systems 120, 122, 124, 126, 128, 130 also interact with the payment operators 160 in such prior systems.

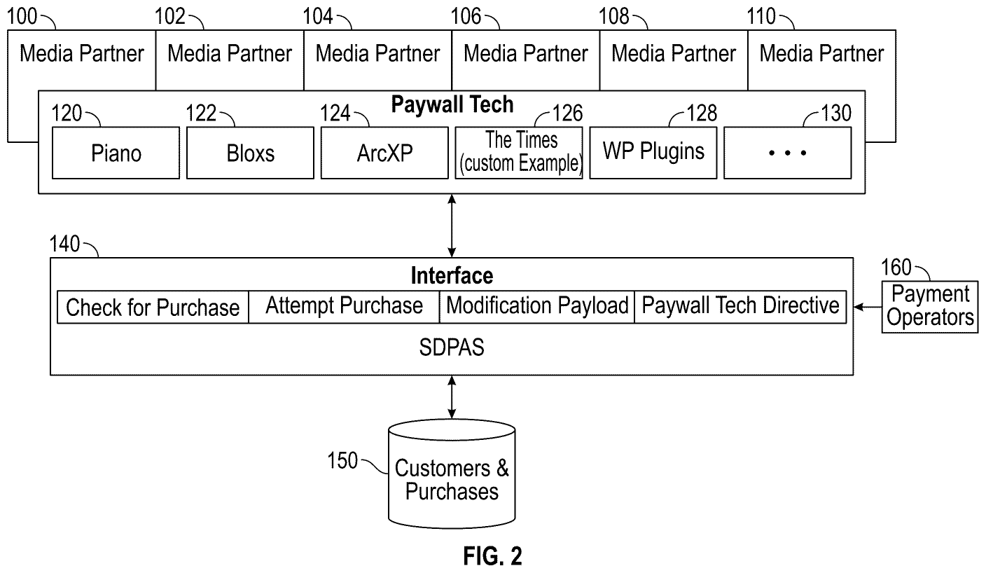

Many on-line media partners 100, 102, 104, 106, 108, 110 have made the decision to implement a paywall, and have a paywall system (e.g., 120) that manages access by customers to the digital content of the on-line media partners 100, 102, 104, 106, 108, 110. However, paywall systems 120, 122, 124, 126, 128, 130 come with many different potential technological challenges. For example, a hard paywall can prevent locked articles behind the paywall from being indexed by search engines. Additionally, a hard paywall will generally prevent locked articles from being shared via social media. Accordingly, it can be difficult for on-line media partners 100, 102, 104, 106, 108, 110 to build their audiences. Thus, the system shown in FIG. 2 provides a technological improvement that overcomes the technological challenges associated with the system of FIG. 1.

FIG. 2 illustrates a context diagram of a single digital product acquisition system (SDPAS) from an on-line media partner. This SDPAS system includes a plurality of on-line media partners 100, 102, 104, 106, 108, 110; a corresponding number of paywall systems 120, 122, 124, 126, 128, 130; a SDPAS 140; one or more customers 150; and payment operators 160. In this system, the SDPAS 140 assists a customer with making an acquisition of a single digital product from one of the on-line media partners 100, 102, 104, 106, 108, 110. The plurality of on-line media partners 100, 102, 104, 106, 108, 110 are managed by the corresponding number of paywall systems 120, 122, 124, 126, 128, 130. However, the SDPAS 140 is positioned between the one or more customers 150 of the on-line media partner and the paywall system that is managing the digital content of the on-line media partners 100, 102, 104, 106, 108, 110 and the paywall systems 120, 122, 124, 126, 128, 130. In this manner, the SDPAS 140 interacts with one or more customers 150 on behalf of the plurality of on-line media partners 100, 102, 104, 106, 108, 110.

In some embodiments, the SDPAS 140 also interacts with the payment operators 160 (instead of, or in addition to interacting with the on-line media partners 100, 102, 104, 106, 108, 110 or the paywall systems 120, 122, 124, 126, 128, 130). Specifically, the SDPAS 140 enables access to one or more portions of digital content (e.g., digital articles, digital newspapers, digital magazine, digital scientific journal, and the like) of the on-line media partners 100, 102, 104, 106, 108, 110 through the paywall systems 120, 122, 124, 126, 128, 130 by a non-subscriber of the on-line media partner that is a customer of the single digital product acquisition system. The SDPAS 140 enables its customers 150 to make one time purchases of digital content, such as digital articles, from the on-line media partners 100, 102, 104, 106, 108, 110 that would be otherwise prevented by the paywall systems 120, 122, 124, 126, 128, 130 without a subscription to the particular on-line media partner that owns the digital article.

In the system shown in FIG. 2, the on-line media partners 100, 102, 104, 106, 108, 110 use one or more paywall systems 120, 122, 124, 126, 128, 130 to meter digital content. The paywall systems 120, 122, 124, 126, 128, 130 manage the subscription experience and digital content access for customers 150 that are willing to purchase a subscription to one of the on-line media partners 100, 102, 104, 106, 108, 110. However, many customers 150 only want to see a single digital article (or a single digital “newspaper”), and are unwilling to purchase a subscription to one of the on-line media partners 100, 102, 104, 106, 108, 110. In such situations, the single digital product acquisition system 140 provides a customer 150 with the option to purchase a single digital product (e.g., a digital article). In some such embodiments, the single digital product acquisition system 140 interacts with the paywall systems 120, 122, 124, 126, 128, 130 to enable access to a single digital product (e.g., a digital article).

In one of more embodiments, the SDPAS 140 tracks the details of the customer 150 (e.g., payment options, balance, purchases, and the like). Furthermore, the SDPAS 140 interfaces with the payment operators 160 to facilitate payment between the customers 150 that purchased single digital product (e.g., a digital article) through the single digital product acquisition system 140 and the on-line media partners 100, 102, 104, 106, 108, 110 that are the owners of the purchased single digital products.

Referring again to the paywall systems 120, 122, 124, 126, 128, 130, these systems handle subscription presentation and management, including customer sign-up, digital content access control, tiered subscription offerings, and the like. In such a system, paywall systems 120, 122, 124, 126, 128, 130 manage digital content of the on-line media partners 100, 102, 104, 106, 108, 110 to block non-subscribers of the on-line media partners from accessing the digital content of the on-line media partners. The paywall systems 120, 122, 124, 126, 128, 130 can manage the digital content in various implementations. In a server-side embodiment, the digital content is blocked on the server side (i.e., the on-line media partners 100, 102, 104, 106, 108, 110 side) of the exchange for non-subscribers. Otherwise stated, the digital content is never delivered to the non-subscriber's browser when they try to access the digital content. In a client-side embodiment, the digital content is delivered to the client side (i.e., the non-subscriber's browser side). However, the digital content is obscured, hidden, encrypted, or the like, for non-subscribers after the digital content has been delivered to the client's browser.

In some embodiments, the SDPAS 140 is in communication with the on-line media partners 100, 102, 104, 106, 108, 110 to provide a mechanism for users (that are not subscribers) to purchase access to a single digital product (e.g., a digital article). In one server-side embodiment, the single digital product acquisition system 140 provides functionality in the on-line media partners' website (i.e., the server-side), which enable customers to sign-up with the SDPAS 140 and purchase a single digital product (e.g., a digital article). The single digital product acquisition system 140 provides the needed functionality to enable the delivery to the client browser of the purchased single digital product by the on-line media partners' website (or access the on-line media partners' website by the client browser).

In one client-side embodiment, the SDPAS 140 provides functionality in the client browser, which enable customers to sign-up with the single digital product acquisition system 140 and purchase a single digital product (e.g., a digital article). The SDPAS 140 provides the needed functionality to unobscure, unencrypt, or otherwise reveal the purchased single digital product, which was previously delivered to the client's browser (but was obscured, hidden, encrypted, or the like).

Below are several scenarios for the purchase of or access to a single digital product (e.g., a digital article), depending on the combination of on-line media partner and their chosen paywall system. In one embodiment where the on-line media partner has selected a server-side paywall system, the paywall system manages the digital content access via a Content Management System (CMS) or a paywall system that hosts server-side functionality. In this embodiment, the SDPAS 140 and the server-side paywall system 120 work together to add functionality to the code of the server-side paywall system 120. The enhanced functionality of the single digital product acquisition system 140 enables the server-side paywall system 120 to check and determine if the user requesting access to the digital content is a new or existing customer of the SDPAS 140 (even if they are not a customer of the on-line media partner).

Additionally, the enhanced functionality of the SDPAS 140 enables the server-side paywall system 120 to present a “Login Now” virtual button to the existing customer of the single digital product acquisition system 140. Further, the enhanced functionality of the SDPAS 140 enables the server-side paywall system 120 to present a “Single Purchase” virtual button to the existing customer, if the single digital product acquisition system 140 determines that the digital content has not been previously purchased. Moreover, if the enhanced functionality of the SDPAS 140 determines that the digital content has already been previously purchased by the existing customer, then the single digital product acquisition system 140 enables the server-side paywall system 120 to present the purchased single digital content to the existing customer. If the user requesting access to the digital content is a not a customer of the single digital product acquisition 140, the enhanced functionality of the SDPAS 140 enables the server-side paywall system 120 to present a “Join Now” or “Sign Up Now” virtual button to the single digital product acquisition system 140.

In another embodiment, the paywall system is implemented by the on-line media partner as a “plug-in” (e.g., WordPress 128). In such an embodiment, the SDPAS 140 is integrated with on-line media partner “plug-in” code (website configuration) to enable presentation of a “Login Now” virtual button to an existing customer of the single digital product acquisition system 140, or a “Sign Up Now” virtual button to a non-existing customer of the single digital product acquisition system 140. In another implementation, the SDPAS 140 is integrated with on-line media partner “plug-in” code (website configuration) to manage the interaction with the user requesting access to the digital content and the virtual button that is presented, as described above in the CMS embodiment.

In still another embodiment, the full content of the single digital product (e.g., a digital article) is delivered to the requesting user and the client-side paywall system 122 manages within the context of the client browser. In such an embodiment, the single digital product acquisition system 140 coordinates with the on-line media partner to include a first script link (e.g., Stubly.js) for the single digital product acquisition system 140 in the header of all digital content, such as digital items/article pages. This first script link manages presentation and behavior of a “Use Single Digital Product Acquisition System” button, with respect to the previously mentioned scenarios, such as current customer of the SDPAS 140, current non-customer of the SDPAS 140, current customer of the SDPAS 140 attempting to view previously purchased single digital product, and current customer of the SDPAS 140 attempting to purchase a previously unpurchased single digital product. In one or more such embodiments, the SDPAS 140 manages inclusion and execution of script that enables viewing of digital content blocked by the paywall system 122 for existing or new purchase.

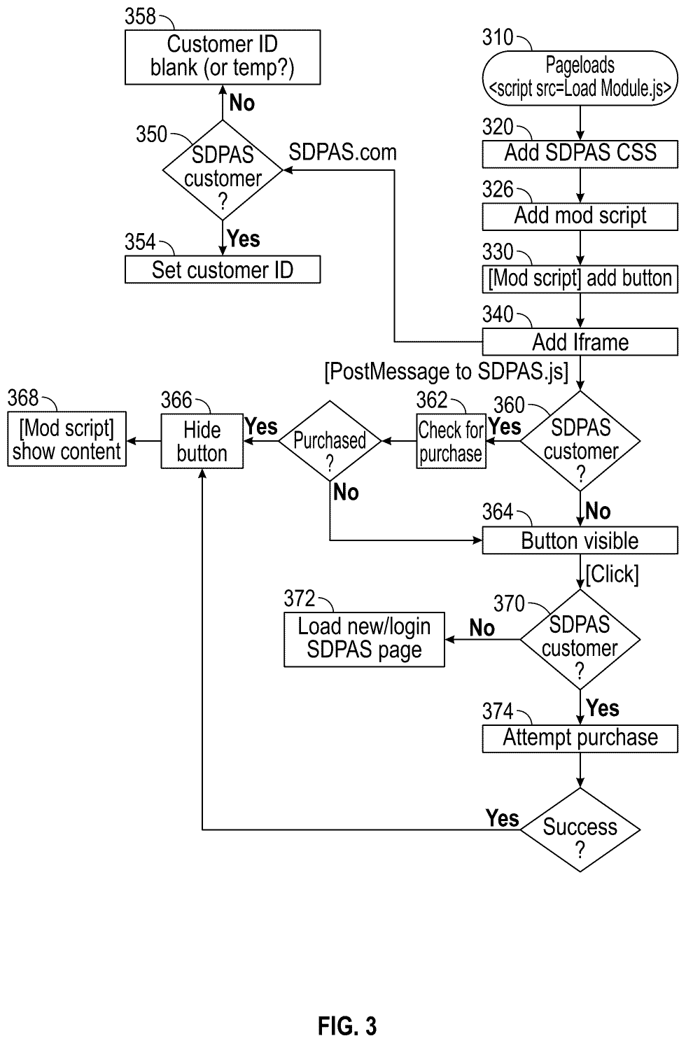

Referring now to FIG. 3, a logical flow diagram for a single digital product acquisition method is described that uses a script link. At the beginning of FIG. 3, the page loads at operation 310, including the script link for the SDPAS 140. In this example, the user navigates to a page that includes the script link. At operation 320, the script link adds a <link> tag that brings in core Cascading Style Sheets (CSS) for User Interface (UI) components of the SDPAS 140 (e.g., “Use Single Digital Product Acquisition System” button). At operation 326, the script link loads a specific Module which contains script that modifies the web page, based on the website where the script link has been included. At operation 330, the modification module creates the “Use Single Digital Product Acquisition System” button. At operation 340, the script link creates a new iFrame with an external script file pointing to the core system of the SDPAS 140 that is hosted on the main server of the single digital product acquisition system 140.

At operation 350, the iFrame checks for cookies of the SDPAS 140 to determine if the user is a customer of the single digital product acquisition system 140 or not. If the user is a customer of the SDPAS 140, the single digital product acquisition system 140 posts a message containing Customer ID, at operation 354. In contrast, if the user is not a customer of the SDPAS 140, the single digital product acquisition system 140 posts a blank message without Customer ID, at operation 358.

At operation 360, the SDPAS 140 has now determined whether or not the user is not a customer of the single digital product acquisition system 140. In this regard, the script link responds to iFrame posted message regarding the presence of the Customer ID for the user. The script link also sets a customer ID attribute on “Use Single Digital Product Acquisition System” button. At operation 362, if a non-blank customer ID was received for the single digital product acquisition system 140, then a “Check For Purchase” REST API is called with that Customer ID to see if the single digital product (e.g., a digital article) requested by the user was previously purchased. At operation 364, if the single digital product (e.g., a digital article) requested by the user was not previously purchased, then the Customer ID attribute is set on the virtual button. This means the single digital product (e.g., a digital article) is blocked, paywall User Interface (UI) is visible, and the “Use Single Digital Product Acquisition System” button is visible. At operation 366, if the single digital product (e.g., a digital article) requested by the user was previously purchased, then the “Use Single Digital Product Acquisition System” button is hidden. Additionally, the “Show Content” modification module script is executed which dismisses (or hides) the paywall block. Accordingly, the single digital product (e.g., a digital article) is now visible, at operation 368.

At operation 370, an embodiment is shown where the user selected the “Use Single Digital Product Acquisition System” button that was displayed in operation 364. In this embodiment, the user is not a customer of the SDPAS 140 or the user is a customer of the SDPAS 140 but there has not been a previous purchase. At operation 372, if the Customer ID attribute is blank, then the “Sign up New Customer/Login Existing Customer” web page is loaded in a new tab. In contrast, at operation 374, if the Customer ID attribute is non-blank, then the “Make Purchase” REST API is called. Additionally, the SDPAS 140 hides the virtual button (as shown in operation 366). Furthermore, the single digital product acquisition system 140 executes the “Show Content” modification module script, which dismisses (or hides) the paywall block. Accordingly, the single digital product (e.g., a digital article) is now visible (as shown in operation 368).

Referring now to the server interaction of the SDPAS 140, the REST API call is used for purchase attempts. In some embodiments, details for this call include (1) Durable_Product_ID, (2) Customer_ID, (3) Host_Name, (4) Page_URL, and (5) Document_Title. The Durable_Product_ID is an identifier that a website uses to track an item, even if original page URL changes. The CUSTOMER_ID is the ID of customer of the SDPAS 140, which is retrieved by the IFrame with a source loaded from server of the SDPAS 140. The Host name is the name of the on-line media partner website. The PAGE_URL is the URL of the page where the purchase is (or was originally) made. Finally, the DOCUMENT_TITLE is the title of the document at time of purchase. This detail assists with the identification of the purchase. This information is also shown to customer of the single digital product acquisition system 140 when they view their list of purchases.

When a single digital product (e.g., a digital article) is attempted to be purchased, the “Check For Purchase” REST API enables the checking for an existing purchase. This API uses the same parameter list as the “Make Purchase” REST API. Referring now to the core of the single digital product acquisition system 140, the core is a resource that is loaded by the iFrame that the script creates on the website page of the single digital product acquisition system 140.

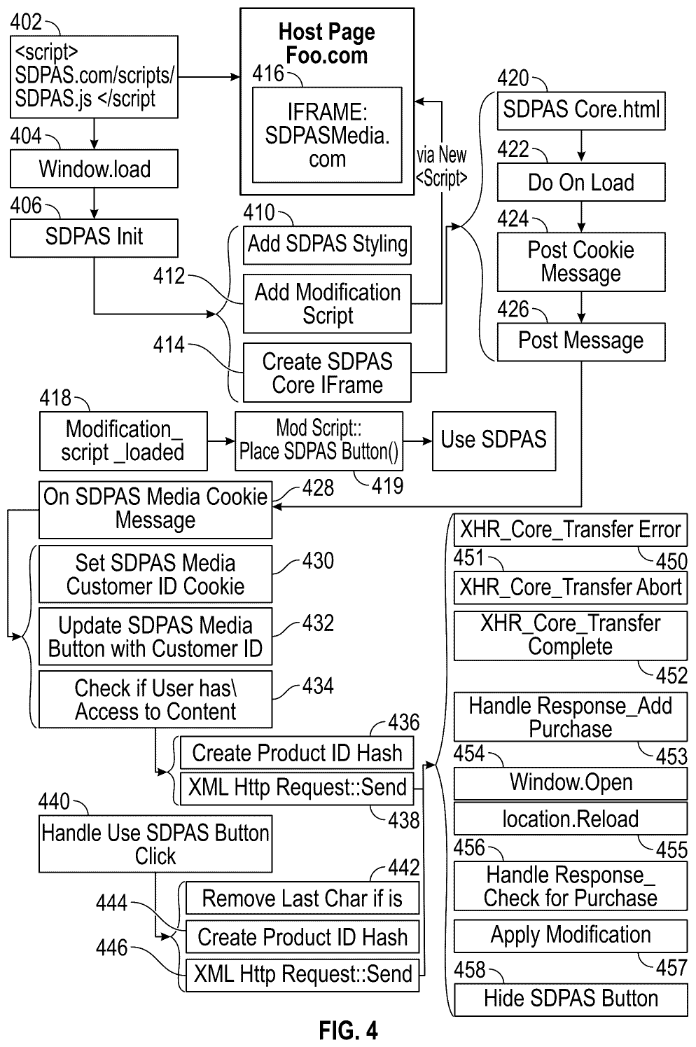

FIG. 4 shows a functional logic flow diagram of the script for the SDPAS 140. This logic flow diagram of the script for the SDPAS 140 provides deeper technical details about flow, functionality, iFrame interaction, and button behavior. At operation 402, the script of the single digital product acquisition system 140 is launched. The script loads the window at operation 404, and then initiates the single digital product acquisition system 140 code at operation 406. Next, the method adds styling for the SDPAS 140 at operation 410, adds modification script for the SDPAS 140 at operation 412, and creates the core iFrame for the SDPAS 140 at operation 414. Adding new modification script at operation 412 leads to an iFrame being launched within the Host page, at operation 416. Furthermore, a modification script load at operation 418 leads to a ModScript::PlaceButton( ) at operation 419.

Creating the core iFrame at operation 414 leads to Core.html at operation 420, DoOnLoad at operation 422, PostCookieMessage at operation 424, and postMessage at operation 426. The postMessage at operation 426 leads to onMediaCookieMessage at operation 428. Continuing, onMediaCookieMessage at operation 428 leads to setMediaCustomerCookie operation 430, updateMediaButtonWithCustomerID at operation 432, and checkIfUserHasAccessToContent at operation 434. These operations in turn lead to createProductIDHash 436 and XMLHttpRequest::Send at operation 438. Still other operations include handleUseButtonClick at operation 440, which leads to removeLastCharlfls at operation 442, creatProdcutIDHash at operation 444, and XMLMttpRequest::send at operation 446. The final group of operations include XHR_Core_TransferError at operation 450, XHR_Core_TransferAbort at operation 451, XHR_Core_TransferComplete at operation 452, HandleResponse_AddPurchase at operation 453, Window. Open at operation 454, Location. Reload at operation at operation 455, HandleResponse_CheckForPurchase at operation 456, applyModification at operation 457, and HideButton at operation 458.

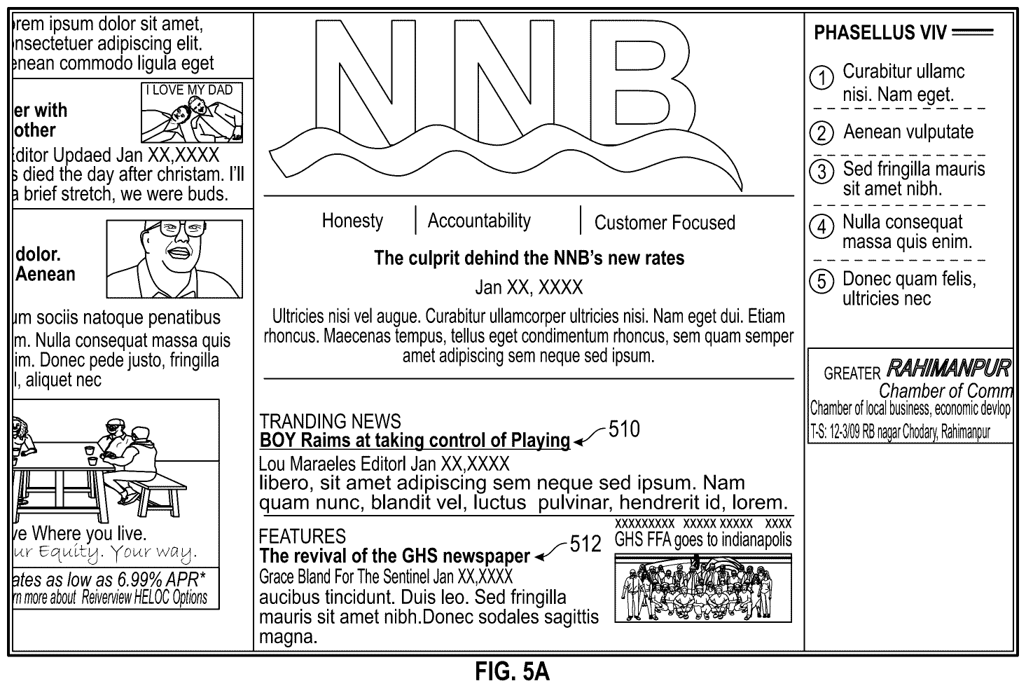

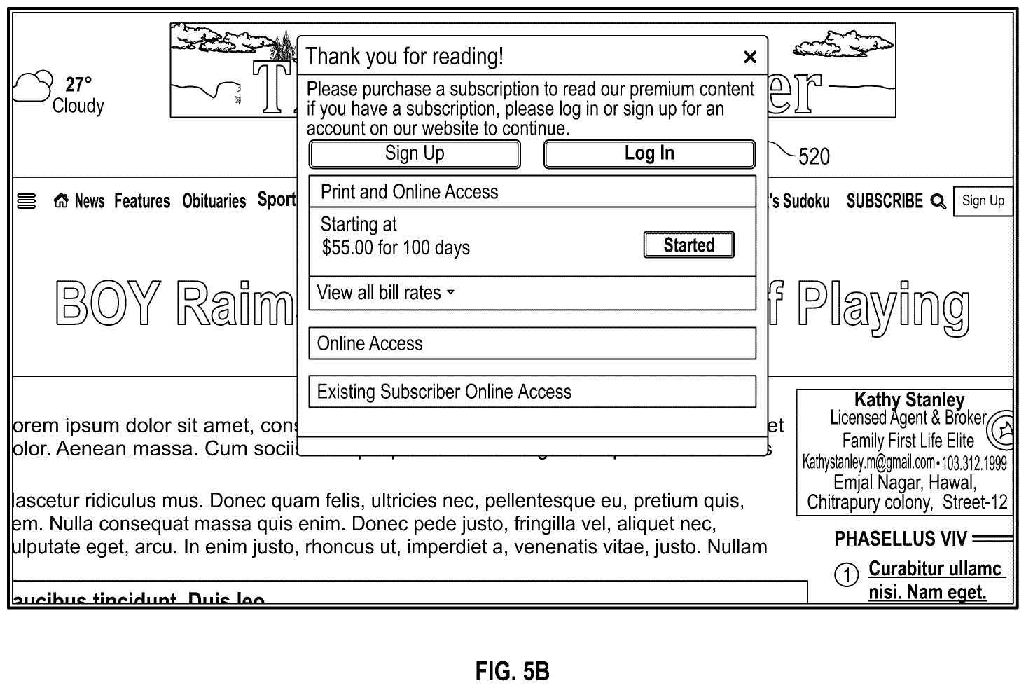

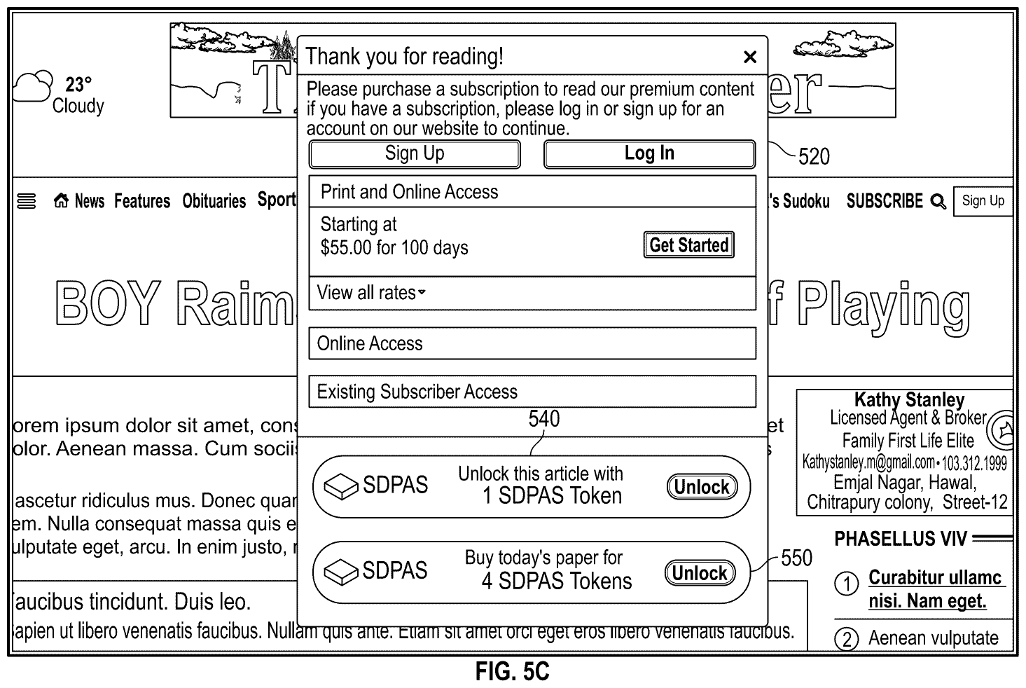

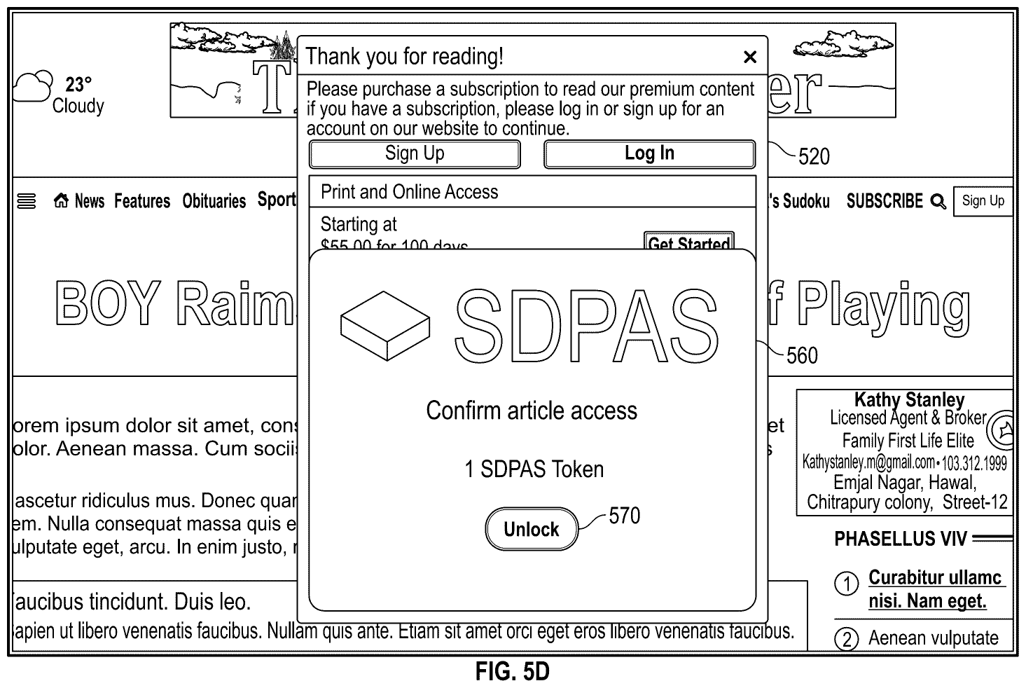

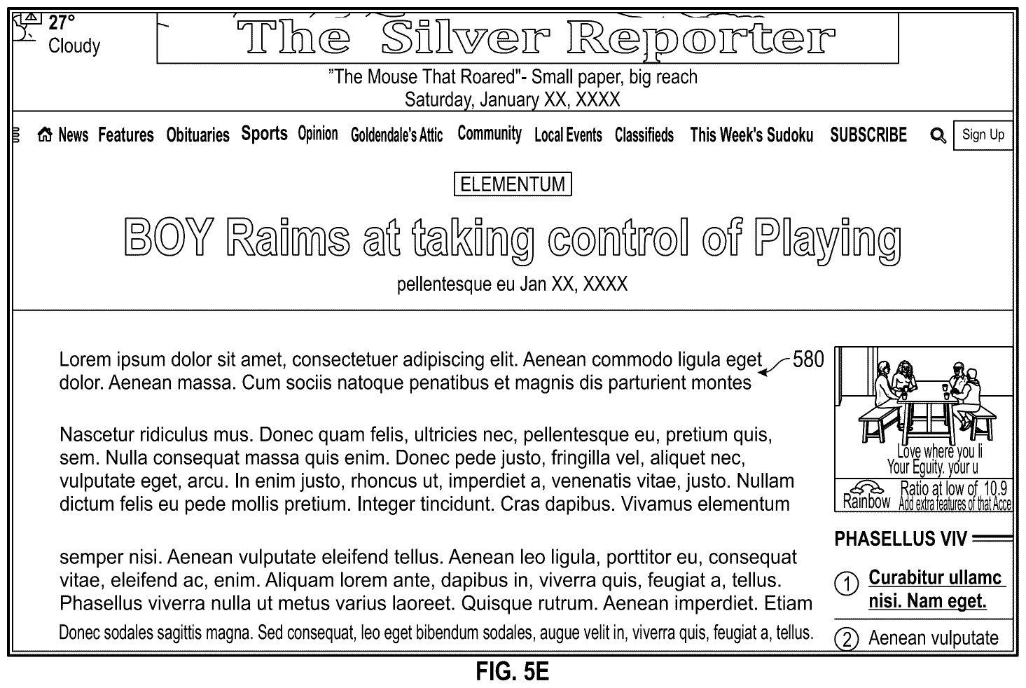

Referring now to FIGS. 5A-5F, screenshots are shown of the single digital product acquisition system 140 in use with the website of an on-line media partner 100 and its associated paywall system 120. Beginning at FIG. 5A, a media partner's website is shown that includes several selectable article headings 510, 512 that are links to full articles. However, the media partner's website shown in FIG. 5A is secured by associated paywall system 120 that prevents non-customers of the on-line media partner 100 from viewing its articles.

Referring now to FIG. 5B, a non-customer of the on-line media partner 100 has attempted to view an article by selecting an article heading 510 that is secured by associated paywall system 120 and a subscription requirement banner 520 has been launched. The subscription requirement banner 520 notifies the non-customer of the on-line media partner 100 that they may view the article by purchasing a 100 day subscription to the on-line media partner in order to view their digital articles. In this example, the 100 day subscription to the on-line media partner is $55.00. This is a much larger commitment than a typically viewer is willing to make that is interested in one article (or maybe one “digital” newspaper or magazine). This results in a frustrated potential customer that leaves the website and an on-line media partner that has lost income and a potential customer due to the large up-front commitment model.

Referring now to FIG. 5C, the media partner's website and subscription requirement banner from FIG. 5B have been augmented with two virtual buttons 540, 550 for the single digital product acquisition system 140. The upper virtual button 540 for the SDPAS 140 may be selected to unlock a single digital article with a single token of the single digital product acquisition system. The lower virtual button 550 for the SDPAS 140 may be selected to unlock a single “digital newspaper” with four tokens of the single digital product acquisition system. This is the digital equivalent of purchasing a printed newspaper from a newspaper stand or newspaper machine. Accordingly, in some embodiments, the digital content of the on-line media partner that is accessible by the user via the interface system is all the on-line media partner's digital content for a set period of time, while in other embodiments, the digital content of the on-line media partner that is accessible by the user via the interface system is a subset of the on-line media partner's digital content for a set period of time.

Referring now to FIG. 5D, the media partner's website and subscription requirement banner 520 is shown after the upper virtual button 540 for the SDPAS 140 has been pressed by a customer and confirmation is provided. The confirmation banner 560 shown of the SDPAS 140 includes an unlock virtual button 570 to access to the digital article that was attempted to be accessed back in FIG. 5A. Finally, in FIG. 5E the media partner's website with the selected article 580 being viewable by the customer of the SDPAS 140, after the customer of the SDPAS 140 confirmed acquisition of the selected article by selecting the unlock virtual button to access to the digital article.

At the website of the single digital product acquisition system 140, the customer account is maintained. For example, in one embodiment the customer account is funded by the customer buying at least one roll of tokens (e.g., $10 for 40 tokens). The balance of the customer's account is updated with a link to the digital article the customer purchased, as well as the date/time, updated account balance, and the like. In some embodiments, another link will be added to the transaction log for the account of the on-line media partner 100. This transaction log also includes an ambiguous user ID, the amount the on-line media partner 100 will receive (e.g., 19¢ for an article or 75¢ if the customer bought the paper), the state and latitude/longitude where the digital article was read, and the date on which the single digital product acquisition system 140 will send (e.g., ACH) their next partner payout payment for their recent sale.

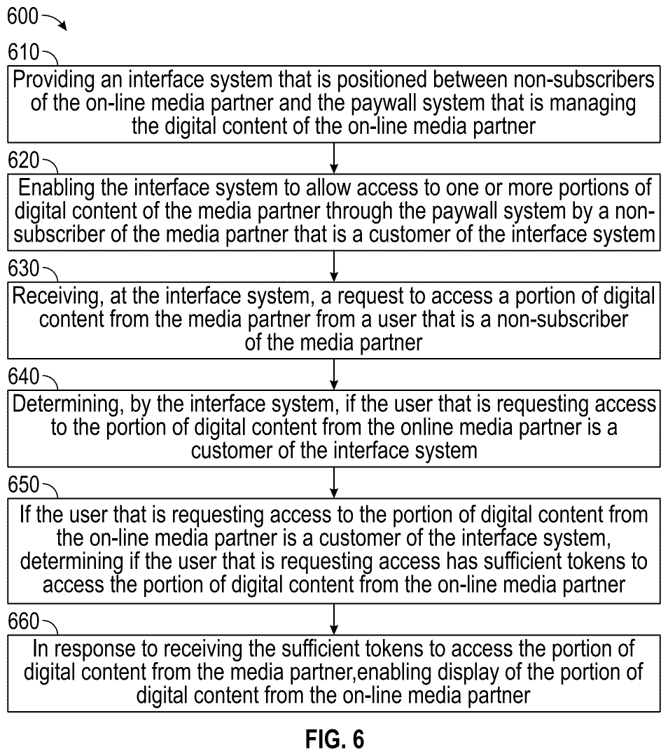

FIG. 6 is a logic diagram showing a method 600 for enabling a single digital product acquisition from an on-line media partner. In such embodiments, a paywall system manages digital content of the on-line media partner to block non-subscribers of the on-line media partner from accessing the digital content of the on-line media partner. In one or more embodiments, the digital content includes a plurality of portions of digital content. As shown in FIG. 6, at operation 610, providing an interface system that is positioned between non-subscribers of the on-line media partner and the paywall system that is managing the digital content of the on-line media partner. At operation 620, enabling the interface system to allow access to one or more portions of digital content of the media partner through the paywall system by a non-subscriber of the media partner that is a customer of the interface system. At operation 630, receiving, at the interface system, a request to access a portion of digital content from the media partner from a user that is a non-subscriber of the media partner. At operation 640, determining, by the interface system, if the user that is requesting access to the portion of digital content from the on-line media partner is a customer of the interface system. At operation 650, if the user that is requesting access to the portion of digital content from the on-line media partner is a customer of the interface system, determining if the user that is requesting access has sufficient tokens to access the portion of digital content from the on-line media partner. At operation 660 in response to receiving the sufficient tokens to access the portion of digital content from the media partner, enabling display of the portion of digital content from the on-line media partner.

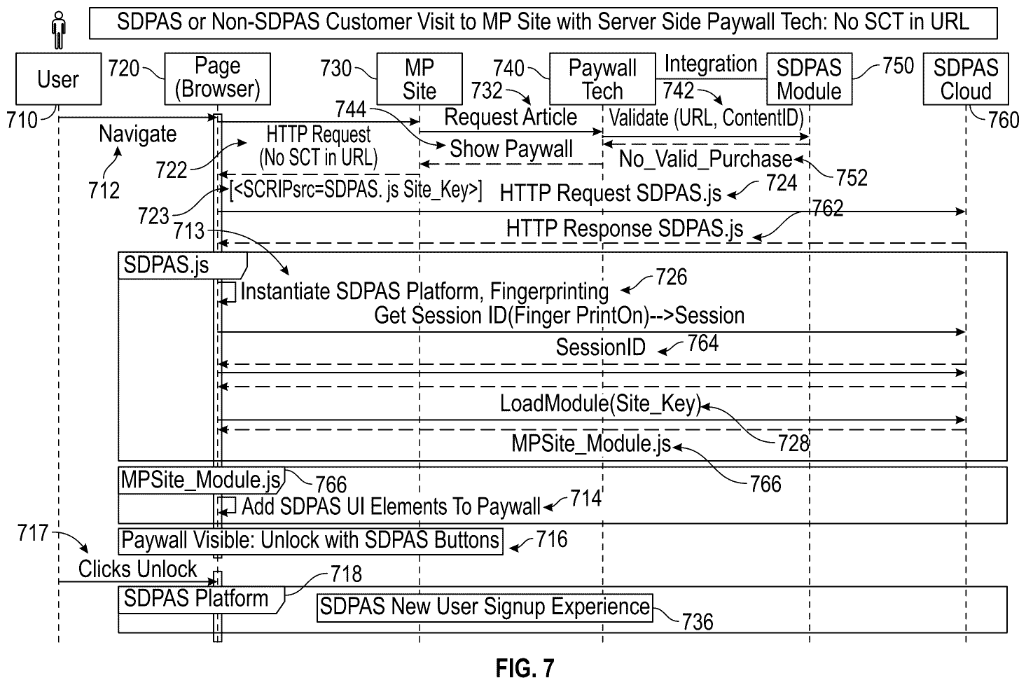

Referring now to FIG. 7, a logical flow diagram for an embodiment of the SDPAS system is shown, in which either a SDPAS customer or non-SDPAS customer visits a media partner website 730 that has implemented server side paywall technology to block digital content from non-subscribers. Further, in this embodiment there is no SDPAS customer token in the Uniform Resource Locator (URL). The user 710 in this embodiment is interacting with a webpage (browser) 720, the media partner website 730, the paywall system 740, the SDPAS module 750, and the SDPAS cloud 760. In some such embodiments, the paywall system 740 is integrated with the SDPAS module 750. In this embodiment, the user 710 navigates 712 to the webpage 720, which sends a HTTP request 722 of the media partner website 730. In this HTTP request 722, there is no SDPAS customer token in the Uniform Resource Locator. At the media partner website 730, the user 710 requests the article 732 from the paywall system 740. The paywall system 740 attempts to validate 742 this article request from the user 710 at the SDPAS module 750 using the URL and the content ID.

As shown in FIG. 7, in this embodiment there is no valid purchase (e.g., the user 710 is not yet a SDPAS customer). Accordingly, the SDPAS module 750 sends a “No Valid Purchase” message 752 to the paywall system 740. The paywall system 740 sends a “show paywall” command 744 to the media partner website 730 because the user 710 is not a direct subscriber with the media partner website 730 and associated paywall system 740. However, the media partner website 730 also sends a SDPAS script element 723 the webpage 720. The SDPAS script element is used to embed executable code or data in the webpage 720 related to the SDPAS system. The user 710, who is still at the webpage 720, then sends an SDPAS HTTP request 724 to the SDPAS cloud 760. In turn, the SDPAS cloud 760 sends an SDPAS HTTP response 762 to the user 710 at the webpage 720. After receiving the SDPAS HTTP response 762, the SDPAS platform is instantiated 713 at the webpage 720.

Next, a Get session ID request 726 is sent from the webpage 720 to the SDPAS cloud 760, after which a Session ID response 764 is sent back from the SDPAS cloud 760 to the webpage 720. Additionally, in some embodiments, a Load Module (Site Key) request 728 is sent from the webpage 720 to the SDPAS cloud 760. In response, a Media Partner Site Module 766 is sent back from the SDPAS cloud 760 to the webpage 720. At this stage, the Media Partner Site Module 766 adds SDPAS user interface elements 714 to the paywall. For example, the Media Partner Site Module 766 makes SDPAS virtual buttons 716 visible on the paywall that may be used to unlock the paywall and provide access to the requested digital content. At the next operation, the user 710 selects a SDPAS virtual button 716 and unlocks 717 the digital content that was previously locked behind the paywall. Finally, the SDPAS platform 718 presents a SDPAS new user signup experience 736 to the user 710.

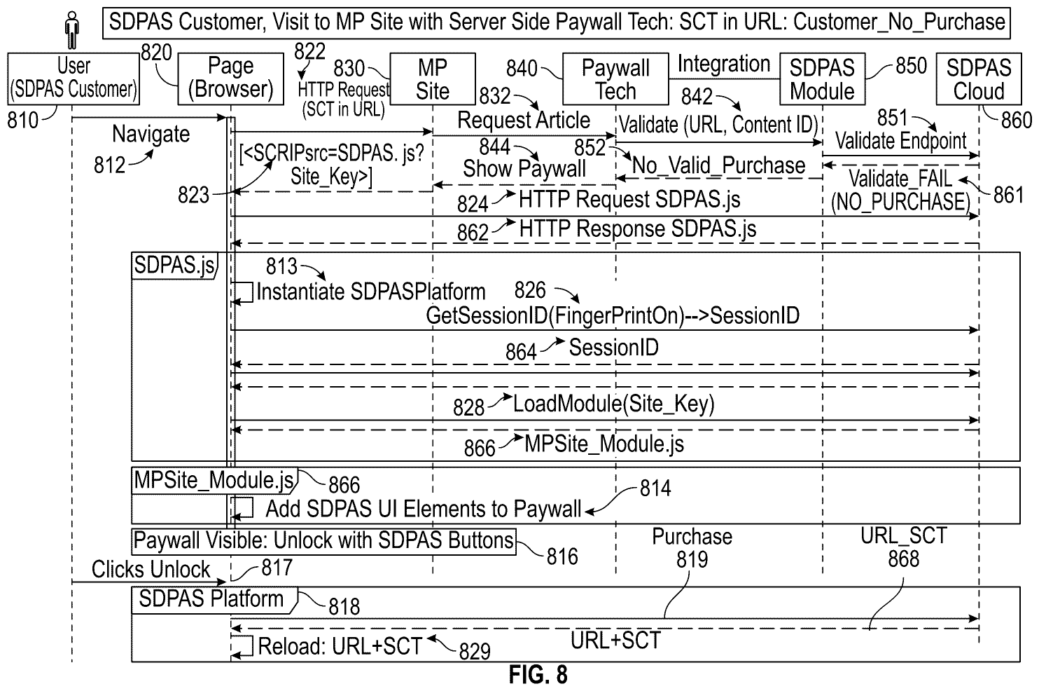

Referring now to FIG. 8, a logical flow diagram for another embodiment of the SDPAS system is shown, in which a SDPAS customer visits a media partner website 830 that has implemented server side paywall technology to block digital content from non-subscribers. Further, in this embodiment there is a SDPAS customer token in the Uniform Resource Locator (URL), but the SDPAS customer has not (yet) purchased the digital content. The user 810 in this embodiment is interacting with a webpage (browser) 820, the media partner website 830, the paywall system 840, the SDPAS module 850, and the SDPAS cloud 860. In some such embodiments, the paywall system 840 is integrated with the SDPAS module 850. In this embodiment, the user 810 navigates 812 to the webpage 820, which sends a HTTP request 822 of the media partner website 830. In this HTTP request 822, there is a SDPAS customer token in the Uniform Resource Locator. At the media partner website 830, the user 810 requests the article 832 from the paywall system 840. The paywall system 840 attempts to validate 842 this article request from the user 810 at the SDPAS module 850 using the URL and the content ID. Since the user 810 is a SDPAS customer, the SDPAS module 850 sends a message to the SDPAS cloud 860 to validate the endpoint 851. However, the SDPAS cloud 860 responds to the SDPAS module 850 that the validation fails 861 because the user 810 has not purchased the article (i.e., digital content).

As shown in FIG. 8, in this embodiment there is no valid purchase (e.g., the user 810 is a SDPAS customer that has not purchased this article). Accordingly, the SDPAS module 850 sends a “No Valid Purchase” message 852 to the paywall system 840. The paywall system 840 sends a “show paywall” command 844 to the media partner website 830 because the user 810 is not a direct subscriber with the media partner website 830 and associated paywall system 840. However, the media partner website 830 also sends a SDPAS script element 823 the webpage 820. The SDPAS script element is used to embed executable code or data in the webpage 820 related to the SDPAS system. The user 810, who is still at the webpage 820, then sends an SDPAS HTTP request 824 to the SDPAS cloud 860. In turn, the SDPAS cloud 860 sends an SDPAS HTTP response 862 to the user 810 at the webpage 820. After receiving the SDPAS HTTP response 862, the SDPAS platform is instantiated 813 at the webpage 820.

Next, a Get session ID request 826 is sent from the webpage 820 to the SDPAS cloud 860, after which a Session ID response 864 is sent back from the SDPAS cloud 860 to the webpage 820. Additionally, in some embodiments, a Load Module (Site Key) request 828 is sent from the webpage 820 to the SDPAS cloud 860. In response, a Media Partner Site Module 866 is sent back from the SDPAS cloud 860 to the webpage 820. At this stage, the Media Partner Site Module 866 adds SDPAS user interface elements 814 to the paywall. For example, the Media Partner Site Module 866 makes SDPAS virtual buttons 816 visible on the paywall that may be used to unlock the paywall and provide access to the requested digital content. At the next operation, the user 810 selects a SDPAS virtual button 816 and unlocks 817 the digital content that was previously locked behind the paywall. Then, the SDPAS platform 818 sends a digital article purchase request 819 to the SDPAS cloud 860, and the SDPAS cloud 860 sends back a response 868 that includes a Uniform Resource Locator with a SDPAS customer token. Finally, the SDPAS platform 818 reloads 829 the Uniform Resource Locator that includes a SDPAS customer token, after which the purchased digital article is presented to the user 810.

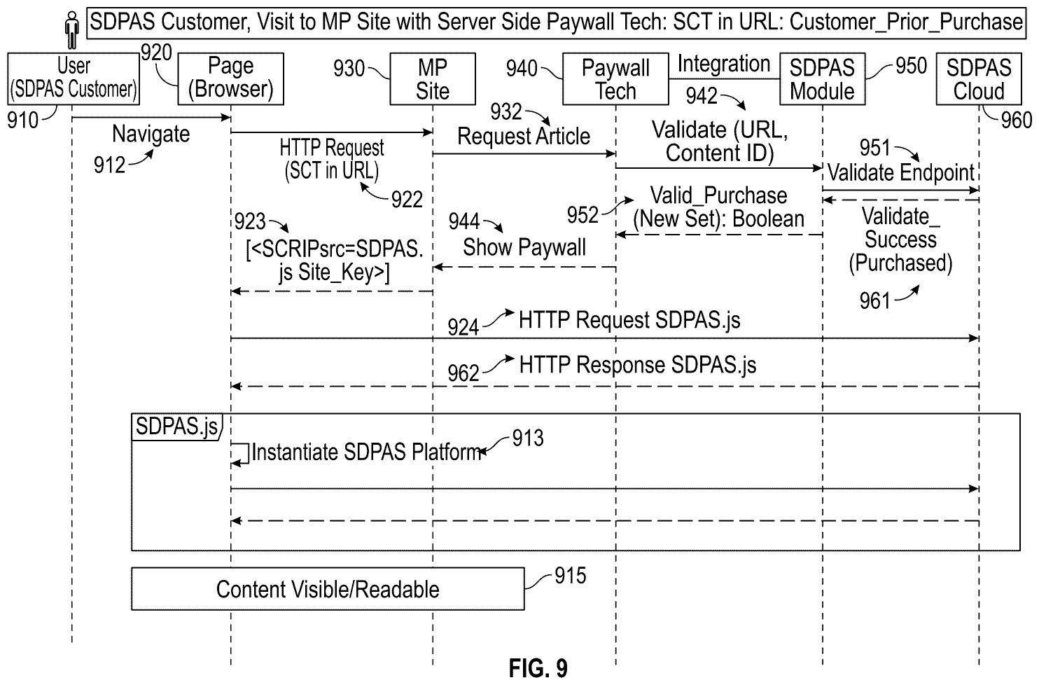

Referring now to FIG. 9, a logical flow diagram for another embodiment of the SDPAS system is shown, in which a SDPAS customer visits a media partner website 930 that has implemented server side paywall technology to block digital content from non-subscribers. Further, in this embodiment there is a SDPAS customer token in the Uniform Resource Locator (URL), and the SDPAS customer has previously purchased the digital content.

The user 910 in this embodiment is interacting with a webpage (browser) 920, the media partner website 930, the paywall system 940, the SDPAS module 950, and the SDPAS cloud 960. In some such embodiments, the paywall system 940 is integrated with the SDPAS module 950. In this embodiment, the user 910 navigates 912 to the webpage 920, which sends a HTTP request 922 of the media partner website 930. In this HTTP request 922, there is a SDPAS customer token in the Uniform Resource Locator. At the media partner website 930, the user 910 requests the article 932 from the paywall system 940. The paywall system 940 attempts to validate 942 this article request from the user 910 at the SDPAS module 950 using the URL and the content ID. Since the user 910 is a SDPAS customer, the SDPAS module 950 sends a message to the SDPAS cloud 960 to validate the endpoint 951. Significantly, since the SDPAS customer has previously purchased the article (i.e., digital content), the SDPAS cloud 960 responds to the SDPAS module 950 that the validation succeeds 961.

As shown in FIG. 9, in this embodiment there is a valid purchase (e.g., the user 910 is a SDPAS customer that has previously purchased this article). Accordingly, the SDPAS module 950 sends a “Valid Purchase” message 952 to the paywall system 940. The paywall system 940 still sends a “show paywall” command 944 to the media partner website 930 because the user 910 is not a direct subscriber with the media partner website 930 and associated paywall system 940. However, the media partner website 930 also sends a SDPAS script element 923 the webpage 920. The SDPAS script element is used to embed executable code or data in the webpage 920 related to the SDPAS system. The user 910, who is still at the webpage 920, then sends an SDPAS HTTP request 924 to the SDPAS cloud 960. In turn, the SDPAS cloud 960 sends an SDPAS HTTP response 962 to the user 910 at the webpage 920. After receiving the SDPAS HTTP response 962, the SDPAS platform is instantiated 913 at the webpage 920. Once the SDPAS platform has been instantiated 913 at the webpage 920, the digital content is visible (e.g., readable) 915 since the SDPAS customer previously purchased this digital content.

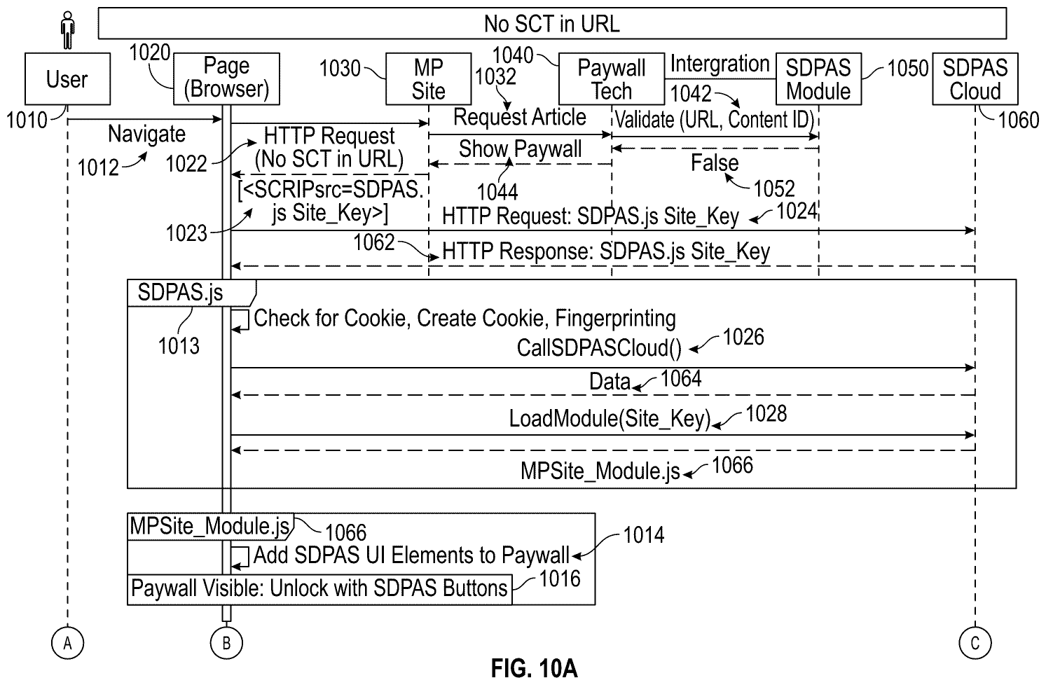

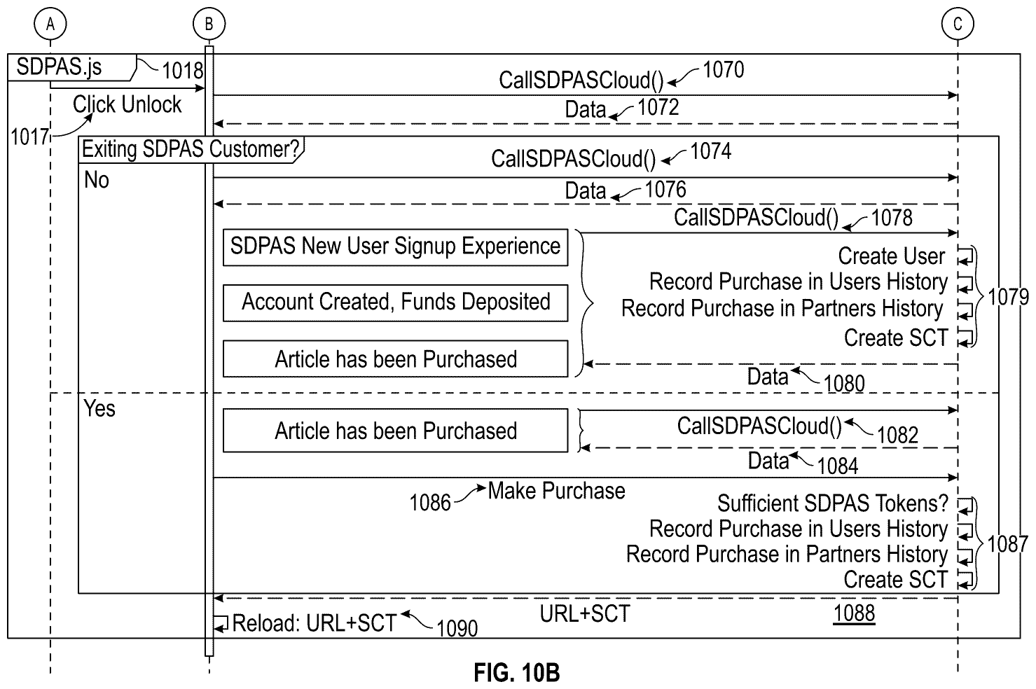

Referring now to FIGS. 10A and 10B, a logical flow diagram for another embodiment of the SDPAS system is shown, in which a SDPAS customer visits a media partner website 730 that has implemented server side paywall technology to block digital content from non-subscribers. Further, in this embodiment there is no SDPAS customer token in the Uniform Resource Locator (URL). This embodiment of FIGS. 10A and 10B is a more detailed version of the embodiment referred to above with respect to FIG. 7.

As shown in FIGS. 10A and 10B, the user 1010 in this embodiment is interacting with a webpage (browser) 1020, the media partner website 1030, the paywall system 1040, the SDPAS module 1050, and the SDPAS cloud 1060. In some such embodiments, the paywall system 1040 is integrated with the SDPAS module 1050. In this embodiment, the user 1010 navigates 1012 to the webpage 1020, which sends a HTTP request 1022 of the media partner website 1030. In this HTTP request 1022, there is no SDPAS customer token in the Uniform Resource Locator. At the media partner website 1030, the user 1010 requests the article 1032 from the paywall system 1040. The paywall system 1040 attempts to validate 1042 this article request from the user 1010 at the SDPAS module 1050 using the URL and the content ID.

In this embodiment there is no valid purchase (e.g., either the user 1010 is not yet a SDPAS customer or the user 1010 is a SDPAS customer that has not yet purchased the digital content). Accordingly, the SDPAS module 1050 sends a “False” message 1052 (i.e., the digital content has not been purchased) to the paywall system 1040. The paywall system 1040 sends a “show paywall” command 1044 to the media partner website 1030 because the user 1010 is not a direct subscriber with the media partner website 1030 and associated paywall system 1040. However, the media partner website 1030 also sends a SDPAS script element 1023 the webpage 1020. The SDPAS script element is used to embed executable code or data in the webpage 1020 related to the SDPAS system. The user 1010, who is still at the webpage 1020, then sends a SDPAS HTTP request 1024 to the SDPAS cloud 1060. In turn, the SDPAS cloud 1060 sends a SDPAS HTTP response 1062 to the user 1010 at the webpage 1020. After receiving the SDPAS HTTP response 1062, the SDPAS platform is instantiated 1013 at the webpage 1020. As part of this instantiation process 1013, the system engages in processes such as checking for cookies, creating cookies, fingerprinting, and the like.

Next, a SDPAS cloud call 1026 is sent from the webpage 1020 to the SDPAS cloud 1060, after which data 1064 (e.g., Session ID) is sent back from the SDPAS cloud 1060 to the webpage 1020. Additionally, in some embodiments, a Load Module (Site Key) request 1028 is sent from the webpage 1020 to the SDPAS cloud 1060. In response, a Media Partner Site Module 1066 is sent back from the SDPAS cloud 1060 to the webpage 1020. At this stage, the Media Partner Site Module 1066 adds SDPAS user interface elements 1014 to the paywall. For example, the Media Partner Site Module 1066 makes SDPAS virtual buttons 1016 visible on the paywall that may be used to unlock the paywall and provide access to the requested digital content.

At the next operation, the user 1010 selects a SDPAS virtual button 1016 on the SDPAS platform 1018 and unlocks 1017 the digital content that was previously locked behind the paywall. This causes the SDPAS platform to send a SDPAS cloud call 1070 to the SDPAS cloud 1060, which in response causes data 1072 to be returned from the SDPAS cloud 1060 to the webpage 1020. How this data is presented to the user 1010 is different depending on whether or not the user 1010 is an existing SDPAS customer. Otherwise stated, an existing SDPAS customer will see a first display of information, while a non-SDPAS customer will see a second display of information.

In a first embodiment where the user 1010 is not an existing SDPAS customer, a SDPAS cloud call 1074 is sent to the SDPAS cloud 1060. In response, the SDPAS cloud 1060 sends back data 1076 requesting information from the user 1010 to initiate a new user signup experience. Next, the user 1010 (who is still not an existing SDPAS customer) sends another SDPAS cloud call 1078 to the SDPAS cloud 1060 that includes various new user sign up information, such as account creation information, funding information, article purchase information, and the like. Using this information, the SDPAS cloud 1060 then able to execute several operations 1079, such as creating the SDPAS customer status for the user, recording purchase in the user history, recording purchase in partners history, and creating SDPAS customer token to facilitate the display of the purchased digital content. In response, the SDPAS cloud 1060 sends back data 1080 to the webpage 1020 that facilitates display of the digital content (e.g., article) that has been purchased.

In a second embodiment where the user 1010 is an existing SDPAS customer, a SDPAS cloud call 1082 is sent to the SDPAS cloud 1060 regarding the purchase of an article (e.g., digital content). In response, the SDPAS cloud 1060 sends back data 1084 requesting information from the user 1010 to facilitate the purchase of an article (e.g., digital content). Next, the user 1010 sends another SDPAS cloud call 1086 to the SDPAS cloud 1060 to request purchase of the digital article. In response to this request, the SDPAS cloud 1060 then able to execute several operations 1087, such as determining if the SDPAS customer has sufficient SDPAS tokens, recording purchase in the user history, recording purchase in partners history, and creating SDPAS customer token to facilitate the display of the purchased digital content. In response, the SDPAS cloud 1060 sends back data 1088 (including the Uniform Resource Locator and the SDPAS customer token) to the webpage 1020 that facilitates display of the digital content (e.g., article) that has been purchased. Finally, the SDPAS platform reloads 1090 the Uniform Resource Locator, which includes a SDPAS customer token, and the purchased digital article is presented to the user 1010.

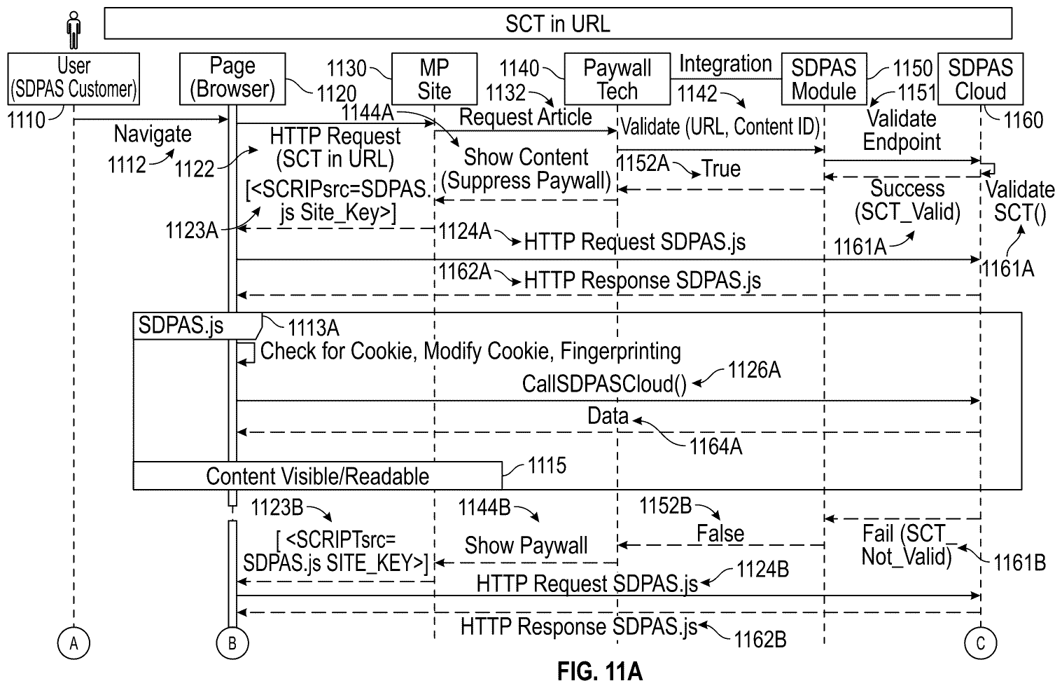

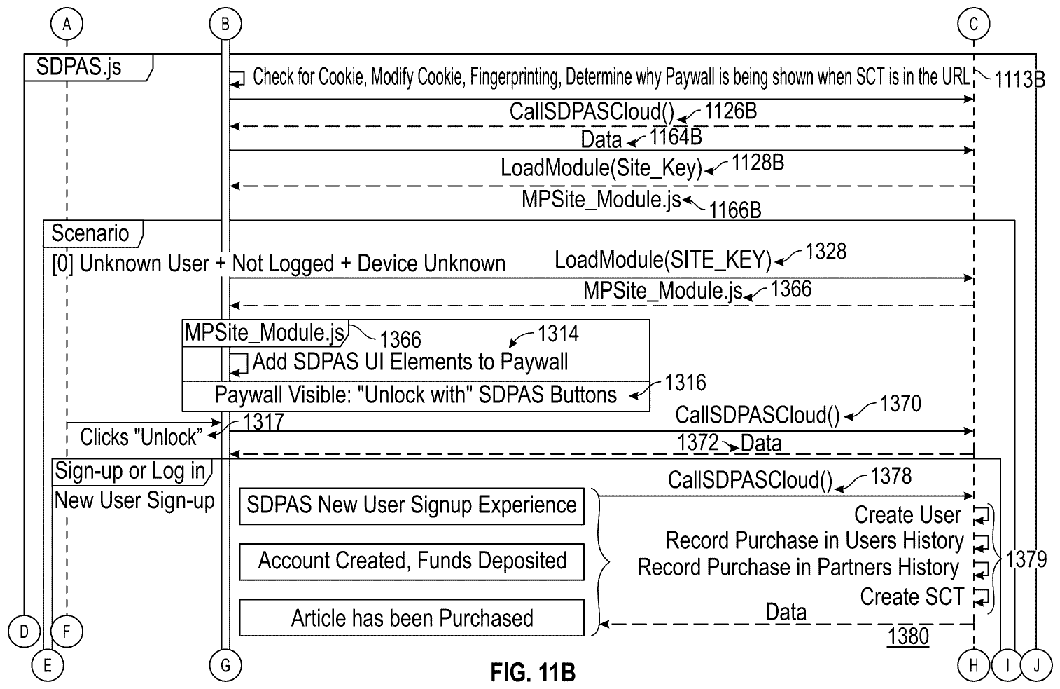

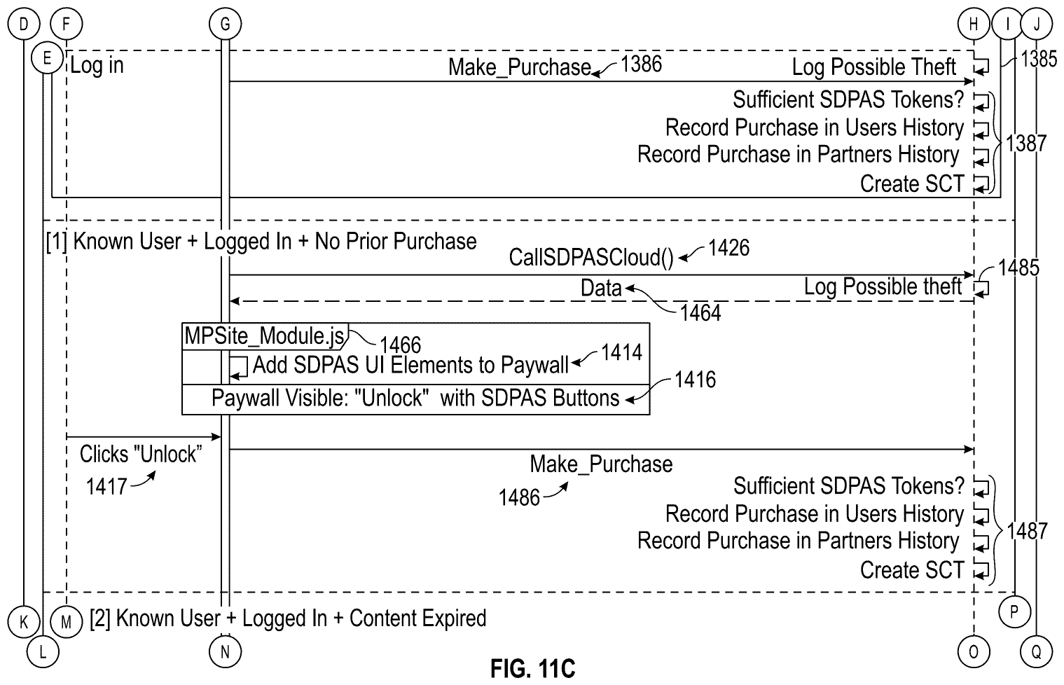

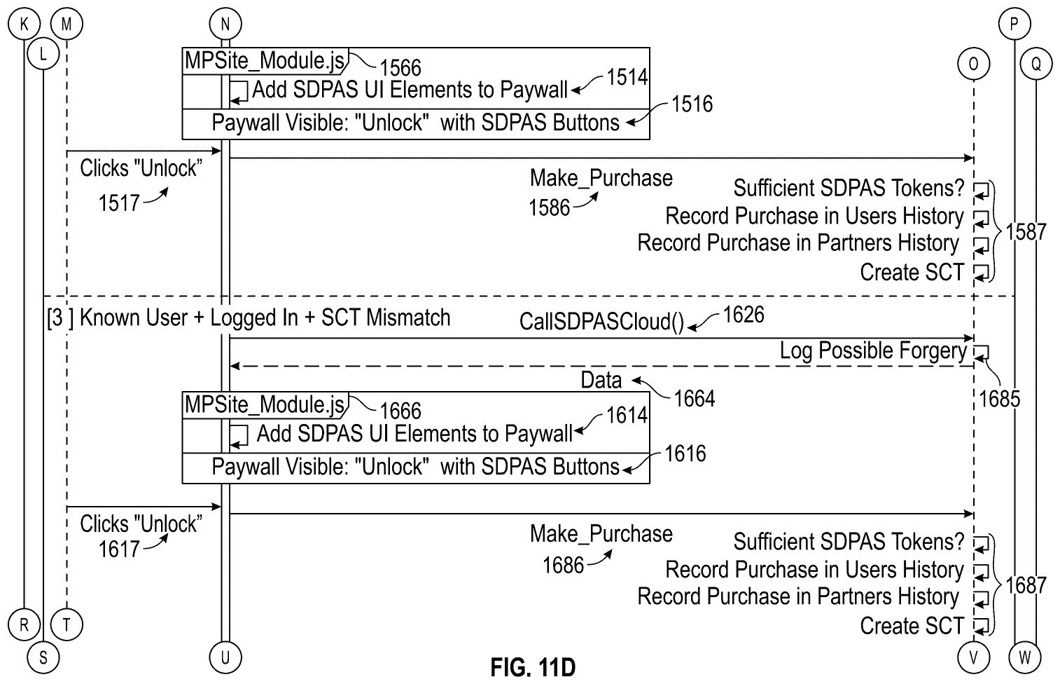

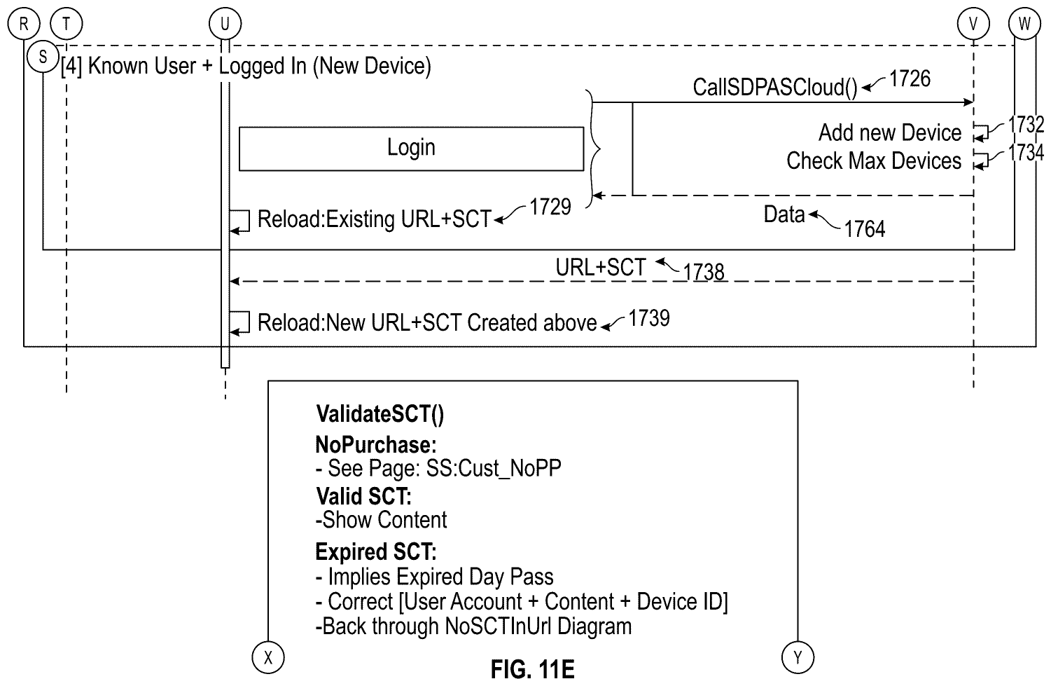

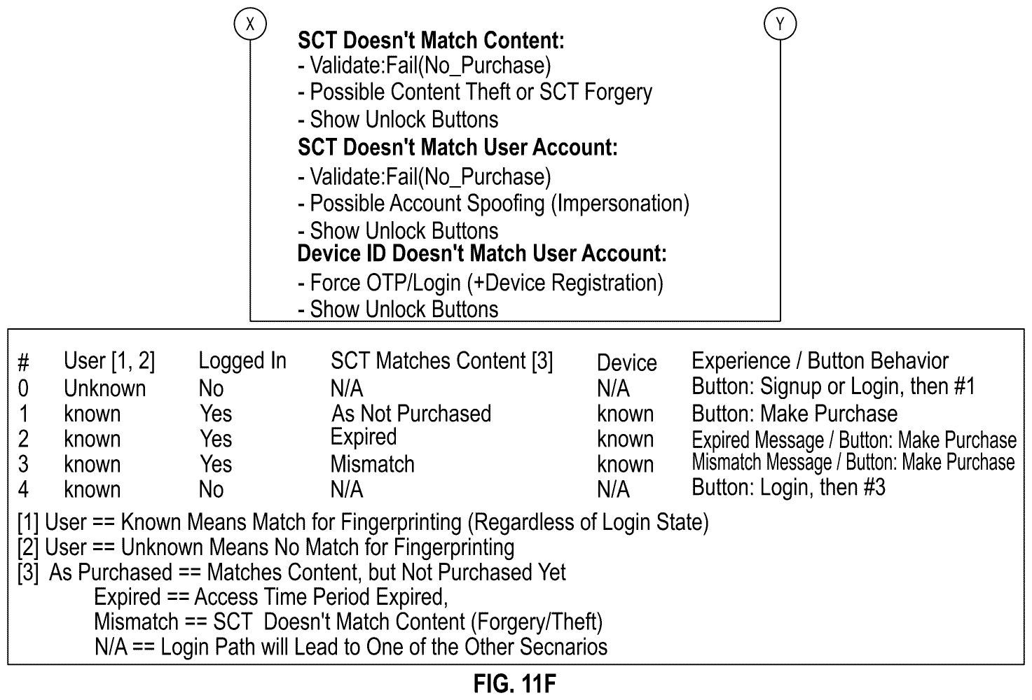

Referring now to FIGS. 11A-11F, a logical flow diagram for another embodiment of the SDPAS system is shown, in which a SDPAS customer visits a media partner website 1130 that has implemented server side paywall technology to block digital content from non-subscribers. Further, in this embodiment there is a SDPAS customer token in the Uniform Resource Locator (URL). These embodiment of FIGS. 11A-11F present more detailed versions of the embodiments referred to above with respect to FIGS. 8 and 9. Specifically, FIGS. 11A-11F present several different possible use case scenarios including (1) Scenario 0: Unknown User+Not Logged+Device Unknown, (2) Scenario 1: Known User+Logged In+No Prior Purchase, (3) Scenario 2: Known User+Logged In+Content Expired, (4) Scenario 3: Known User+Logged In+SCT Mismatch, and (5) Scenario 4: Known User+Logged In (New Device).

The user 1110 in this embodiment is interacting with a webpage (browser) 1120, the media partner website 1130, the paywall system 1140, the SDPAS module 1150, and the SDPAS cloud 1160. In some such embodiments, the paywall system 1140 is integrated with the SDPAS module 1150. In this embodiment where there is a SDPAS customer token in the URL that is valid, the user 1110 navigates 1112 to the webpage 1120, which sends a HTTP request 1122 of the media partner website 1130. In this HTTP request 1122, there is a SDPAS customer token in the Uniform Resource Locator. At the media partner website 1130, the user 1110 requests the article 1132 from the paywall system 1140. The paywall system 1140 attempts to validate 1142 this article request from the user 1110 at the SDPAS module 1150 using the URL and the content ID. Since the user 1110 is a SDPAS customer, the SDPAS module 1150 sends a message to the SDPAS cloud 1160 to validate the endpoint 1151. Significantly, since the SDPAS customer has previously purchased the article (i.e., digital content), the SDPAS cloud 1160 responds to the SDPAS module 1150 that the validation succeeds 1161A.

As shown in FIG. 11A, in this embodiment there is a valid purchase (e.g., the user 1110 is a SDPAS customer that has previously purchased this article). Accordingly, the SDPAS module 1150 sends a “True” (i.e., Valid purchase) message 1152A to the paywall system 1140. In this embodiment, the paywall system 1140 suppresses the paywall and sends a “show content” command 1144A to the media partner website 1130 even though the user 1110 is not a direct subscriber with the media partner website 1130 and associated paywall system 1140. However, the media partner website 1130 also sends a SDPAS script element 1123A the webpage 1120. The SDPAS script element is used to embed executable code or data in the webpage 1120 related to the SDPAS system. The user 1110, who is still at the webpage 1120, then sends an SDPAS HTTP request 1124A to the SDPAS cloud 1160. In turn, the SDPAS cloud 1160 sends an SDPAS HTTP response 1162A to the user 1110 at the webpage 1120.

After receiving the SDPAS HTTP response 1162A, the SDPAS platform is instantiated 1113A at the webpage 1120. As part of this instantiation process 1113A, the system engages in processes such as checking for cookies, creating cookies, fingerprinting, and the like. Next, a SDPAS cloud call 1126A is sent from the webpage 1120 to the SDPAS cloud 1160, after which data 1164A (e.g., Session ID) is sent back from the SDPAS cloud 1160 to the webpage 1120. Once the SDPAS platform has been instantiated 1113A at the webpage 1120, the digital content is visible (e.g., readable) 1115 since the SDPAS customer previously purchased this digital content.

Referring now to another embodiment where there is a SDPAS customer token in the URL that is not valid, the SDPAS cloud 1160 responds to the SDPAS module 1150 that the validation fails 1161B because the SDPAS customer token is not valid. Next, the SDPAS module 1150 sends a “False” message 1152B (i.e., the SDPAS customer token is not valid) to the paywall system 1140. The paywall system 1140 sends a “show paywall” command 1144B to the media partner website 1130 because the user 1110 is not a direct subscriber with the media partner website 1130 and associated paywall system 1140. However, the media partner website 1130 also sends a SDPAS script element 1123B the webpage 1120. The SDPAS script element is used to embed executable code or data in the webpage 1120 related to the SDPAS system.

The user 1110, who is still at the webpage 1120, then sends a SDPAS HTTP request 1124B to the SDPAS cloud 1160. In turn, the SDPAS cloud 1160 sends a SDPAS HTTP response 1162B to the user 1110 at the webpage 1120. After receiving the SDPAS HTTP response 1162B, the SDPAS platform is instantiated 1113B at the webpage 1120. As part of this instantiation process 1113B, the system engages in processes such as checking for cookies, creating cookies, fingerprinting, determining why the paywall is being shown when there is a SDPAS customer token in the URL, and the like.

Next, a SDPAS cloud call 1126B is sent from the webpage 1120 to the SDPAS cloud 1160, after which data 1164B (e.g., Session ID) is sent back from the SDPAS cloud 1160 to the webpage 1120. Additionally, in some embodiments, a Load Module (Site Key) request 1128B is sent from the webpage 1120 to the SDPAS cloud 1160. In response, a Media Partner Site Module 1166B is sent back from the SDPAS cloud 1160 to the webpage 1120.

### Scenario 0: Unknown User+not Logged+Device Unknown:

In this scenario 0, the user is a non-SDPAS customer that is not logged into the system, and who is using an unknown device. In this embodiment, a Load Module (Site Key) request 1328 is sent from the webpage 1120 to the SDPAS cloud 1160. In response, a Media Partner Site Module 1366 is sent back from the SDPAS cloud 1160 to the webpage 1120. At this stage, the Media Partner Site Module 1366 adds SDPAS user interface elements 1314 to the paywall. For example, the Media Partner Site Module 1366 makes SDPAS virtual buttons 1316 visible on the paywall that may be used to unlock the paywall and provide access to the requested digital content.

At the next operation, the user 1110 selects a SDPAS virtual button 1316 and unlocks 1317 the digital content that was previously locked behind the paywall. This causes the SDPAS platform to send a SDPAS cloud call 1370 to the SDPAS cloud 1160, which in response causes data 1372 to be returned from the SDPAS cloud 1160 to the webpage 1120. In this embodiment where the user 1110 is signing up an existing SDPAS customer or logging in as an existing SDPAS customer, a SDPAS cloud call 1378 is sent to the SDPAS cloud 1160 that includes various new user sign up information, such as account creation information, funding information, article purchase information, and the like. Using this information, the SDPAS cloud 1160 then able to execute several operations 1379, such as creating the SDPAS customer status for the user, recording purchase in the user history, recording purchase in partners history, and creating SDPAS customer token to facilitate the display of the purchased digital content. In response, the SDPAS cloud 1160 sends back data 1380 to the webpage 1120 that facilitates display of the digital content (e.g., article) that has been purchased.

Once logged in, the user 1110 (and SDPAS customer) sends another SDPAS cloud call 1386 to the SDPAS cloud 1160 to request purchase of the digital article. In some embodiments, the SDPAS cloud 1160 creates a log for a possible theft 1385, if any evidence indicates such a potential. In response to this request, the SDPAS cloud 1160 then able to execute several operations 1387, such as determining if the SDPAS customer has sufficient SDPAS tokens, recording purchase in the user history, recording purchase in partners history, and creating SDPAS customer token to facilitate the display of the purchased digital content.

### Scenario 1: Known User+Logged In+No Prior Purchase:

In this scenario 1, the user is a SDPAS customer that is logged into the system, and the SDPAS customer has not made a prior purchase. In this embodiment, a SDPAS cloud call 1426 is sent from the webpage 1120 to the SDPAS cloud 1160, after which data 1464 (e.g., Session ID) is sent back from the SDPAS cloud 1160 to the webpage 1120. In some embodiments, the SDPAS cloud 1160 creates a log for a possible theft 1485, if any evidence indicates such a potential. After receiving the data 1464, the Media Partner Site Module 1466 is instantiated at the webpage 1120. At this stage, the Media Partner Site Module 1466 adds SDPAS user interface elements 1414 to the paywall. For example, the Media Partner Site Module 1466 makes SDPAS virtual buttons 1416 visible on the paywall that may be used to unlock the paywall and provide access to the requested digital content.

At the next operation, the user 1110 selects a SDPAS virtual button 1416 and unlocks 1417 the digital content that was previously locked behind the paywall. Once logged in, the user 1110 (and SDPAS customer) sends a SDPAS cloud call 1486 to the SDPAS cloud 1160 to request purchase of the digital article. In response to this request, the SDPAS cloud 1160 then able to execute several operations 1487, such as determining if the SDPAS customer has sufficient SDPAS tokens, recording purchase in the user history, recording purchase in partners history, and creating SDPAS customer token to facilitate the display of the purchased digital content.

### Scenario 2: Known User+Logged In+Content Expired:

In this scenario 2, the user is a SDPAS customer that is logged into the system, and the SDPAS customer is trying to access content that has expired. In this embodiment, the Media Partner Site Module 1566 is instantiated at the webpage 1120. At this stage, the Media Partner Site Module 1566 adds SDPAS user interface elements 1514 to the paywall. For example, the Media Partner Site Module 1566 makes SDPAS virtual buttons 1516 visible on the paywall that may be used to unlock the paywall and provide access to the requested digital content.

At the next operation, the user 1110 selects a SDPAS virtual button 1516 and unlocks 1517 the digital content that was previously locked behind the paywall. Once logged in, the user 1110 (and SDPAS customer) sends a SDPAS cloud call 1586 to the SDPAS cloud 1160 to request purchase of the digital article. In response to this request, the SDPAS cloud 1160 then able to execute several operations 1587, such as determining if the SDPAS customer has sufficient SDPAS tokens, recording purchase in the user history, recording purchase in partners history, and creating SDPAS customer token to facilitate the display of the purchased digital content. However, since the digital content has expired, the user 1110 is not able to access the digital content.

### Scenario 3: Known User+Logged In+SCT Mismatch:

In this scenario 3, the user is a SDPAS customer that is logged into the system, and there is a mismatch with the SDPAS customer token. In this embodiment, a SDPAS cloud call 1626 is sent from the webpage 1120 to the SDPAS cloud 1160, after which data 1664 (e.g., Session ID) is sent back from the SDPAS cloud 1160 to the webpage 1120. In some embodiments, the SDPAS cloud 1160 creates a log for a possible theft 1685, if any evidence indicates such a potential. After receiving the data 1664, the Media Partner Site Module 1666 is instantiated at the webpage 1120. At this stage, the Media Partner Site Module 1666 adds SDPAS user interface elements 1614 to the paywall. For example, the Media Partner Site Module 1666 makes SDPAS virtual buttons 1616 visible on the paywall that may be used to unlock the paywall and provide access to the requested digital content.

At the next operation, the user 1110 selects a SDPAS virtual button 1616 and unlocks 1617 the digital content that was previously locked behind the paywall. Once logged in, the user 1110 (and SDPAS customer) sends a SDPAS cloud call 1686 to the SDPAS cloud 1160 to request purchase of the digital article. In response to this request, the SDPAS cloud 1160 then able to execute several operations 1687, such as determining if the SDPAS customer has sufficient SDPAS tokens, recording purchase in the user history, recording purchase in partners history, and creating SDPAS customer token to facilitate the display of the purchased digital content. However, since there is a mismatch with the SDPAS customer token, the user 1110 is not able to access the digital content.

### Scenario 4: Known User+Logged in (New Device):

In this scenario 4, the user is a SDPAS customer that is logged into the system, but who is logging in from a new device. In this embodiment, a SDPAS cloud call 1726 is sent from the webpage 1120 to the SDPAS cloud 1160 to facilitate the login process. Once logged into the system, the SDPAS cloud 1160 performs the “add new device” operation 1732 to the registry. Additionally, the SDPAS cloud 1160 performs the “check maximum number of devices” operation 1734 in the registry. This operation 1734 is used to confirm that the user still has the ability to add another new device, and are not already at their maximum number of devices. In response, data 1764 (e.g., Session ID) is sent back from the SDPAS cloud 1160 to the webpage 1120.

One reason why it is important to track the number of devices that are used on a SDPAS customer account is to prevent fraud and abuse. For example, if there were no restrictions on the number of devices that were allowed to used by a SPDAS customer (or SPDAS customer account), then a user could buy a SPDAS Day Pass and put their URL with the SPDAS Day Pass information on a message board (or other public forum). This could result in everyone on the forum having access to that digital newspaper (or other digital content) all day long. Accordingly, in some embodiments, the SDPAS platform validates the “fingerprint” of the SPDAS customer's browser as a “device”, and limits the maximum the number of devices that may be associated with the SDPAS purchase.

In this regard, browser fingerprinting is the systematic collection of information about a device for identification purposes. In some embodiments, browser fingerprinting operates by collecting and analyzing numerous data points from a user's browser and device to create a unique identifier for that device. This fingerprinting technique is configured to pinpoint differences between different browsers and devices, even between identical models or operating systems. By controlling the maximum number of devices they may be added, the SDPAS platform prevents the “Break Once, Run Everywhere” (BORE) scenario of fraudulent misappropriation of confidential URLs (or other confidential information).

Next, the SDPAS platform reloads 1729 the existing Uniform Resource Locator that includes a SDPAS customer token and the purchased digital article is presented to the user 1110. At the stage, the SDPAS cloud 1160 sends additional data 1738 (including a new Uniform Resource Locator and SDPAS customer token) to the webpage 1120 that facilitates display of digital content (e.g., an article) that has been purchased. The SDPAS platform reloads 1739 the new Uniform Resource Locator that includes the SDPAS customer token, which enables the purchased digital article to be presented to the user 1110.

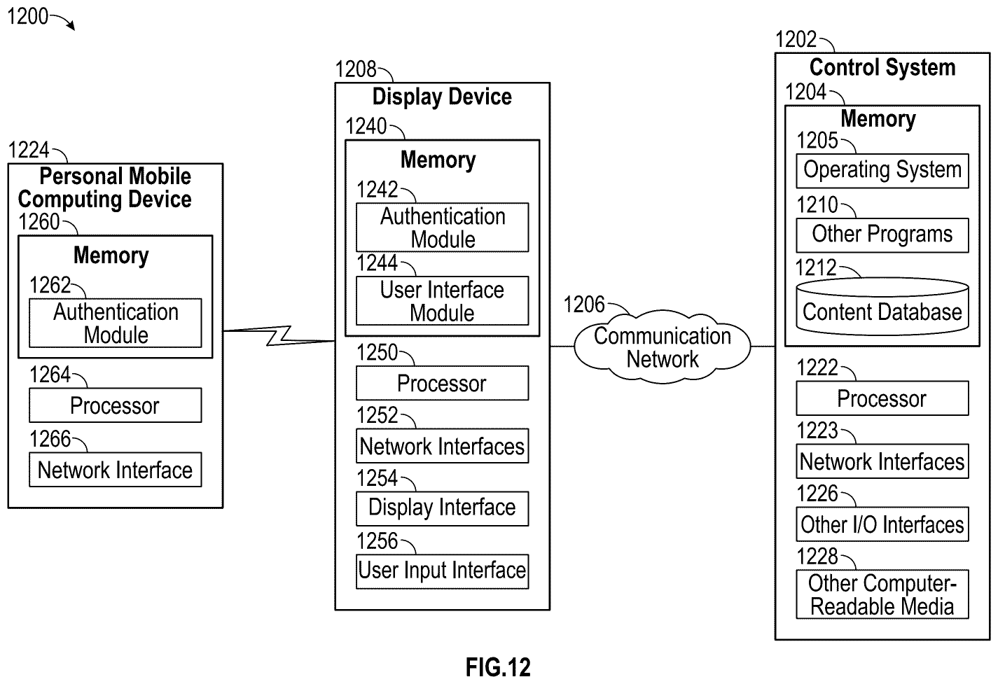

FIG. 12 shows a system diagram that describes one implementation of computing systems for implementing embodiments described herein. System 1200 includes control system 1202, one or more display devices 1208, and one or more personal mobile computing devices 1224. As described herein, the control system 1202 is a computing device that can perform functionality described herein for implementing an operating system that provides a user interface for storing content. One or more special purpose computing systems may be used to implement the control system 1202. Accordingly, various embodiments described herein may be implemented in software, hardware, firmware, or in some combination thereof. The control system 1202 includes memory 1204, one or more processors 1222, network interface 1223, other input/output (I/O) interfaces 1226, and other computer-readable media 1228. In some embodiments, the control system 1202 may be implemented by cloud computing resources.

Processor 1222 includes one or more processing devices that execute computer instructions to perform operations (e.g., actions), including at least some embodiments described herein. In various embodiments, the processor 1222 may include one or more central processing units (“CPU”), programmable logic, or other processing circuitry.

Memory 1204 may include one or more various types of non-volatile and/or volatile storage technologies. Examples of memory 1204 include, but are not limited to, flash memory, hard disk drives, optical drives, solid-state drives, various types of random-access memory (“RAM”), various types of read-only memory (“ROM”), other computer-readable storage media (also referred to as processor-readable storage media), or other memory technologies, or any combination thereof. Memory 1204 may be utilized to store information, including computer-readable instructions that are utilized by processor 1222 to perform actions, including at least some embodiments described herein.

Memory 1204 may have stored thereon operating system 1205. The operating system 1205 authenticates users of personal mobile computing devices 1224 via display devices 1208 and provides a user interface for storing and accessing content, as described herein. Memory 1204 may include a content database 1212 for storing content in accordance with the user interface. Memory 1204 may also store other programs 1210. The other programs 1210 may include other operating systems, user applications, or other computer programs that are accessible to the personal mobile computing device 1224 via the display device 1208.

Network interface 1223 is configured to communicate with other computing devices, such as the display devices 1208, via a communication network 1206. Network interface 1223 includes transmitters and receivers (not illustrated) to send and receive data associated with the user interface described herein.

Other I/O interfaces 1226 may include interfaces for various other input or output devices, such as audio interfaces, other video interfaces, USB interfaces, physical buttons, keyboards, haptic interfaces, tactile interfaces, or the like. Other computer-readable media 1228 may include other types of stationary or removable computer-readable media, such as removable flash drives, external hard drives, or the like.

The display devices 1208 are computing devices that are remote from the control system 1202. In some embodiments, the display devices 1208 may include one or more computing devices and display devices. The display devices 1208 coordinate authentication between the personal mobile computing devices 1224 and the control system 1202. The display devices 1208 receive input from the users of the personal mobile computing device 1224 and provide the input to the control system 1202. The display devices 1208 receive the graphical user interfaces for the user interface to be presented to the users of the personal mobile computing devices 1224.

One or more special-purpose computing systems may be used to implement the display devices 1208. Accordingly, various embodiments described herein may be implemented in software, hardware, firmware, or in some combination thereof. The display devices 1208 include memory 1240, one or more processors 1250, network interface 1252, display interface 1254, and user input interface 1256. The memory 1240, processor 1250, and network interface 1252 may be similar to, include similar components, or incorporate embodiments of memory 1204, processor 1222, and network interface 1223 of control system 1202, respectively. Thus, processor 1250 includes one or more processing devices that execute computer instructions to perform operations (e.g., actions), including at least some embodiments described herein. In various embodiments, the processor 1250 may include one or more CPUs, programmable logic, or other processing circuitry. The network interfaces 1252 is also configured to communicate with the personal mobile computing devices 1224, such as via Bluetooth or other short-range communication protocol or technology.

Memory 1240 may include one or more various types of non-volatile and/or volatile storage technologies. Memory 1240 may be utilized to store information, including computer-readable instructions that are utilized by processor 1250 to perform actions, including at least some embodiments described herein. Memory 1240 may store various modules or programs, including authentication module 1242 and user interface module 1244. The authentication module 1242 may perform actions that coordinate the authentication between the personal mobile computing devices 1224 and the control system 1202. The user interface module 1244 receives graphical user interface data from the control system 1202 for display or presentation, via the display interface 1254, to the user of the personal mobile computing devices 1224. The user interface module 1244 also receives user input via the user input interface 1256 and provides that input back to the control system 1202. In various embodiments, one or more capacitive, radar, infrared, LIDAR, or other type of gesture capturing sensors may be used to receive the user input. In some other embodiments, the user interface module 1244 may receive user inputs via other input mechanisms, such as a mouse, stylus, voice-recognition, or other input sensors. Memory 1240 may also store other programs.

The personal mobile computing devices 1224 are computing devices that are remote from the display devices 1208 and the control system 1202. When a personal mobile computing device 1224 is within a threshold range of the display device 1208 or when a user of the personal mobile computing device 1224 activates authentication, the personal mobile computing device 1224 provides authentication data or information to the display device 1208 for forwarding to the control system 1202. In various embodiments, the personal mobile computing device 1224 is separate from the display device 1208, such that a user can walk up to a display device 1208 with the personal mobile computing device 1224 to initiate the process described herein to have the display device 1208 present the user interface received from the control system 1202. The user can then provide input to the display device 1208, such as with hand gestures or arm movement, to manipulate the user interface and select content for display.

One or more special-purpose computing systems may be used to implement the personal mobile computing devices 1224. Accordingly, various embodiments described herein may be implemented in software, hardware, firmware, or in some combination thereof.

The personal mobile computing devices 1224 include memory 1260, one or more processors 1264, and a network interface 1266. The memory 1260, processor 1264, and network interface 1266 may be similar to, include similar components, or incorporate embodiments of memory 1240, processor 1250, and network interfaces 1252 of display devices 1208, respectively. Thus, processor 1264 includes one or more processing devices that execute computer instructions to perform operations (e.g., actions), including at least some embodiments described herein. In various embodiments, the processor 1264 may include one or more CPUs, programmable logic, or other processing circuitry. The network interface 1266 is configured to communicate with the display devices 1208, but not with the control system 1202.

Memory 1260 may include one or more various types of non-volatile and/or volatile storage technologies. Memory 1260 may be utilized to store information, including computer-readable instructions that are utilized by processor 1264 to perform actions, including at least some embodiments described herein. Memory 1260 may store various modules or programs, including authentication module 1262. The authentication module 1262 may perform actions to communicate authentication information to a display device 1208 when within a threshold distance from the display device or when activated by a user.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. A system for enabling a single digital product acquisition from an on-line media partner, wherein a paywall system manages digital content of the on-line media partner to block non-subscribers of the on-line media partner from accessing the digital content of the on-line media partner, the system comprising:
a memory that stores computer instructions and a processor that when executing the computer instructions causes the system to:
enable an interface system to allow access to the digital content of the on-line media partner through the paywall system by a non-subscriber of the on-line media partner that is a customer of the interface system;
receive, at the interface system, a request to access a portion of digital content controlled by the on-line media partner from a user that is a non-subscriber of the on-line media partner;
determine, by the interface system, if the user that is requesting access to the portion of digital content controlled by the on-line media partner is a customer of the interface system;
when the user that is requesting access to the portion of digital content controlled by the on-line media partner is a customer of the interface system, determine that the user that is requesting access has sufficient tokens to access the portion of digital content controlled by the on-line media partner; and
in response to receiving the sufficient tokens to access the portion of digital content controlled by the on-line media partner, enable display of the portion of digital content controlled by the on-line media partner.

2. The system of claim 1, wherein the memory includes further computer instructions that when executing the computer instructions further cause the system to:
if the user that is requesting access to a portion of digital content controlled by the on-line media partner is not a customer of the interface system, prompt the user that is requesting access to join the interface system.

3. The system of claim 1, wherein the memory includes further computer instructions that when executing the computer instructions further cause the system to:
if the interface system determines that the user requesting access is a customer of the interface system but does not have sufficient tokens to access to the digital content of the on-line media partner, enable the requesting user to acquire more tokens; and
initiate communication with a payment operator to enable the requesting user to acquire more tokens.

4. The system of claim 1, wherein paywall system manages digital content of an on-line media partner using Content Management System (CMS).

5. The system of claim 1, wherein the interface system is operatively connected with a payment operator to enable a customer of the interface system to transfer funds for one time use digital tokens.

6. The system of claim 1, wherein the memory includes further computer instructions that when executing the computer instructions further cause the system to:
enable the paywall system to check if a user requesting access to a portion of digital content controlled by the on-line media partner is a customer of the interface system; and
if the paywall system determines that the user requesting access to a portion of digital content controlled by the on-line media partner is a customer of the interface system, provide access to the portion of digital content controlled by the on-line media partner once the portion of digital content has been brokered by the customer of the interface system.

7. The system of claim 1, wherein the interface system is integrated into a website of the on-line media partner as a plug-in to enable presentation of the interface system in an iFrame.

8. The system of claim 1, wherein the digital content includes a plurality of portions of digital content, and wherein the interface system coordinates with the on-line media partner to include an interface system link to each of the plurality of portions of digital content.

9. The system of claim 1, wherein the digital content controlled by the on-line media partner that are requested by users are downloaded to the user's browser, and the interface system manages whether the digital content controlled by the on-line media partner are viewable based on the user's status as a customer of the interface system.

10. A system for enabling a single digital product acquisition from an on-line media partner, wherein a paywall system manages digital content of the on-line media partner to block non-subscribers of the on-line media partner from accessing the digital content of the on-line media partner using a server-side paywall, the system comprising:
a memory that stores computer instructions and a processor that when executing the computer instructions causes the system to:
receive, at the interface system, a request to access the digital content controlled by the on-line media partner from a user that is a non-subscriber of the on-line media partner, wherein the request is forwarded from the paywall system that received the request to access the digital content controlled by the on-line media partner from the user;
determine, by the interface system, if the user that is requesting access to the digital content controlled by the on-line media partner is a customer of the interface system;
when the user that is requesting access to the digital content controlled by the on-line media partner is a customer of the interface system, determine that the user requesting access has sufficient tokens to access the digital content controlled by the on-line media partner;
in response to determining that sufficient tokens have been received to enable access to the digital content controlled by the on-line media partner from the user, enable download of the digital content controlled by the on-line media partner to a computer at which the user is requesting access; and
enable display of the downloaded digital content controlled by the on-line media partner on the computer at which the user is requesting access.

11. The system of claim 10, wherein the memory includes further computer instructions that when executing the computer instructions further cause the system to:
if the user that is requesting access to the digital content controlled by the on-line media partner is not a customer of the interface system, prompt the user that is requesting access to join the interface system.

12. The system of claim 10, wherein the memory includes further computer instructions that when executing the computer instructions further cause the system to:
if the interface system determines that the user requesting access is a customer of the interface system but does not have sufficient tokens to access to the digital content of the on-line media partner, enable the requesting user to acquire more tokens; and
initiate communication with a payment operator to enable the requesting user to acquire more tokens.

13. The system of claim 10, wherein the memory includes further computer instructions that when executing the computer instructions further cause the system to:
in response to determining that sufficient tokens have been received to enable access the digital content controlled by the on-line media partner from the user, download an interface system platform to the computer at which the user is requesting access.

14. The system of claim 10, wherein the memory includes further computer instructions that when executing the computer instructions further cause the system to:
in response to determining that sufficient tokens have been received to enable access the digital content controlled by the on-line media partner from the user, instantiate an interface system platform to the computer at which the user is requesting access.

15. The system of claim 10, wherein the memory includes further computer instructions that when executing the computer instructions further cause the system to:
after instantiating an interface system platform to the computer at which the user is requesting access, adding user interface elements to the server-side paywall of the paywall system that manages digital content of the on-line media partner to block non-subscribers of the on-line media partner from accessing the digital content of the on-line media partner.

16. The system of claim 10, wherein the digital content of the on-line media partner that is accessible by the user via the interface system is a single digital product or is multiple digital products.

17. The system of claim 10, wherein the digital content of the on-line media partner that is accessible by the user via the interface system is all the on-line media partner's digital content for a set period of time.

18. The system of claim 10, wherein the digital content of the on-line media partner that is accessible by the user via the interface system is a subset of the on-line media partner's digital content for a set period of time.

19. A system for enabling a single digital product acquisition from an on-line media partner, wherein a paywall system manages digital content of the on-line media partner to block non-subscribers of the on-line media partner from accessing the digital content of the on-line media partner using a server-side paywall, the system comprising:
a memory that stores computer instructions and a processor that when executing the computer instructions causes the system to:
receive, at the interface system, a request to access the digital content controlled by the on-line media partner from a user that is a non-subscriber of the on-line media partner, wherein the request is forwarded from the paywall system that received the request to access the digital content controlled by the on-line media partner from the user;
determine, by the interface system, that the user requesting access to the digital content controlled by the on-line media partner is not a customer of the interface system;
enable, by the interface system, the user requesting access to the digital content controlled by the on-line media partner an opportunity to become a customer of the interface system by completing new user sign up actions;
in response to the completion of the new user sign up actions by the user, establishing the user requesting access to the digital content controlled by the on-line media partner as a customer of the interface system;
determine if the user requesting access has sufficient tokens to access the digital content controlled by the on-line media partner;
in response to determining that sufficient tokens have been received to enable access the digital content controlled by the on-line media partner from the user, enable download of the digital content controlled by the on-line media partner to a computer at which the user is requesting access; and
enable display of the downloaded digital content controlled by the on-line media partner on the computer at which the user is requesting access.

20. The system of claim 19, wherein the memory includes further computer instructions that when executing the computer instructions further cause the system to:
if the interface system determines that the user requesting access is a customer of the interface system but does not have sufficient tokens to access to the digital content of the on-line media partner, enable the requesting user to acquire more tokens; and
initiate communication with a payment operator to enable the requesting user to acquire more tokens.
